(19) United States
(12) Patent Application Publication
(10) Pub. No.: US 2025/0229698 A1
(43) Pub. Date: Jul. 17, 2025

(54) VEHICLE LAMP

(71) Applicant: KOITO MANUFACTURING CO., LTD., Tokyo (JP)

(72) Inventor: Yasuyuki KATO, Shizuoka (JP)

(21) Appl. No.: 19/096,748

(22) Filed: Apr. 1, 2025

Related U.S. Application Data
(63) Continuation of application No. PCT/JP2023/032674, filed on Sep. 7, 2023.

(30) Foreign Application Priority Data
Oct. 7, 2022 (JP) 2022-162484
Oct. 7, 2022 (JP) 2022-162485
Oct. 7, 2022 (JP) 2022-162486

(51) Int. Cl. B60Q 1/08; B60Q 1/068; B60Q 1/076; F21S 41/657; F21W 102/155; F21Y 115/10

(52) U.S. Cl. CPC B60Q 1/085; B60Q 1/068; B60Q 1/076; F21S 41/657; F21W 2102/155; F21Y 2115/10

(57) ABSTRACT

A vehicle lamp includes a right optical unit that emits at least a low beam light distribution pattern and is arranged on a right side of a vehicle, a left optical unit 71 that emits at least a low beam light distribution pattern and is arranged on a left side of the vehicle, and a lamp controller that individually displaces, in a vertical direction, a first emission direction of the low beam light distribution pattern emitted by the right optical unit and a second emission direction of the low beam light distribution pattern emitted by the left optical unit, based on a position of a target object located in front of the vehicle.

### CROSS REFERENCE TO RELATED APPLICATIONS

This application is a continuation application of International Patent Application No. PCT/JP2023/032674, filed on Sep. 7, 2023, which claims priority from Japanese Patent Application Nos. 2022-162484, 2022-162485, and 2022-162486, filed on Oct. 7, 2022, respectively, with the Japan Patent Office, the disclosures of which are incorporated herein in their entireties by reference.

### TECHNICAL FIELD

The present disclosure relates to a vehicle lamp.

### BACKGROUND

Japanese Patent Laid-Open Publication No. 2022-015772 discloses a vehicle lamp control device capable of independently controlling the orientation of each headlamp by a lamp ECU provided in each of left and right headlamps, according to a pitch angle or roll angle calculated based on the vehicle height of a host vehicle.

Further, Japanese Patent Laid-Open Publication No. 2014-051191 discloses a vehicle headlamp device that prohibits light emission based on a high beam light distribution pattern when the turning radius of a host vehicle while traveling is smaller than a predetermined value, in order to emit light over a wide area without causing glare to the driver of a preceding vehicle.

Further, Japanese Patent Laid-Open Publication No. 2014-040140 discloses a control device for a lamp that controls a high beam light distribution pattern to expand the range of a non-emission area when a preceding vehicle is located within the non-emission area, based on the displacement direction and displacement speed of the preceding vehicle, in order to prevent glare to the preceding vehicle even when the relative position of the preceding vehicle changes significantly in the left-right direction.

### SUMMARY

For example, in a traveling state where the relative position of an oncoming vehicle (an example of a target object) changes significantly in the left-right direction, there is a possibility that the oncoming vehicle may enter the emission area of a vehicle lamp. This may cause glare to the oncoming vehicle. Meanwhile, there is a demand to maintain good visibility not only in the vicinity of a vehicle but also at greater distances from the vehicle. In other words, there is a need to prevent glare to a target object present in front of a vehicle while also maintaining good long-distance visibility in front of the vehicle.

The present disclosure aims to provide a vehicle lamp capable of achieving both the maintenance of long-distance visibility for a vehicle and the prevention of glare.

Further, an adaptive driving beam (ADB) light distribution pattern is known. The ADB light distribution pattern is a type of high beam light distribution pattern that does not emit light to areas where preceding vehicles and oncoming vehicles are present and that varies a non-emission area based on the presence or absence and positions of preceding vehicles and oncoming vehicles. The ADB light distribution pattern is known to be effective in preventing glare to the occupant of a preceding vehicle or oncoming vehicle. However, for example, when a vehicle is turning, there is a possibility of causing glare to the occupant of an oncoming vehicle, leaving room for improvement.

The present disclosure also aims to provide a vehicle lamp that further reduces glare to the occupant of an oncoming vehicle when a vehicle is turning.

According to one aspect of the present disclosure, a vehicle lamp includes a right optical unit that emits at least a low beam light distribution pattern and is arranged on a right side of a vehicle, a left optical unit that emits at least a low beam light distribution pattern and is arranged on a left side of the vehicle, and a lamp control unit that individually displaces, in a vertical direction, a first emission direction of the low beam light distribution pattern emitted by the right optical unit and a second emission direction of the low beam light distribution pattern emitted by the left optical unit, based on a position of a target object located in front of the vehicle.

According to the above configuration, the lamp control unit individually displaces the first emission direction of the low beam light distribution pattern emitted by the right optical unit and the second emission direction of the low beam light distribution pattern emitted by the left optical unit in the vertical direction, based on the position of the target object. In other words, such a vehicle lamp may suppress glare while avoiding any unnecessary deterioration in long-distance visibility for the vehicle by individually displacing the first emission direction and the second emission direction in the vertical direction. Thus, the vehicle lamp according to the above configuration may achieve both the maintenance of long-distance visibility for the vehicle and the prevention of glare.

Further, according to one aspect of the present disclosure, a vehicle lamp includes an optical unit that emits at least a low beam light distribution pattern, and a lamp control unit that displaces an emission direction of the low beam light distribution pattern in a vertical direction based on a type of a target object located in front of a vehicle where the vehicle lamp is mounted.

According to the above configuration, the lamp control unit displaces the emission direction of the low beam light distribution pattern emitted by the optical unit in the vertical direction, based on the type of the target object. For example, when the target object is an oncoming vehicle, the likelihood of causing glare to the target object is higher than when the target object is a preceding vehicle. Therefore, it is desirable that the downward movement amount of the emission direction of the low beam light distribution pattern is greater when the target object is an oncoming vehicle than the downward movement amount of the emission direction of the low beam light distribution pattern when the target object is a preceding vehicle. The vehicle lamp having the above configuration may achieve both the maintenance of long-distance visibility for the vehicle and the prevention of glare by appropriately displacing the emission direction of the low beam light distribution pattern in the vertical direction based on the type of the target object.

Further, according to one aspect of the present disclosure, a vehicle lamp includes an optical unit that emits at least an adaptive driving beam (ADB) light distribution pattern, and a lamp control unit that controls the optical unit, in which the lamp control unit controls the optical unit to deactivate the ADB light distribution pattern when the vehicle is turning and an oncoming vehicle is present in front of a vehicle where the vehicle lamp is mounted.

According to the above configuration, when the vehicle is turning and an oncoming vehicle is present, the ADB light distribution pattern is deactivated. This may further reduce glare to the occupant of the oncoming vehicle.

According to the present disclosure, it is possible to provide a vehicle lamp capable of achieving both the maintenance of long-distance visibility for a vehicle and the prevention of glare.

Further, according to the present disclosure, it is possible to provide a vehicle lamp that further reduces glare to the occupant of an oncoming vehicle when a vehicle is turning.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view of a vehicle equipped with a vehicle lamp according to an embodiment of the present disclosure (hereinafter, simply referred to as the “present embodiment”).

FIG. 2 is a block diagram of a system configuration including the vehicle lamp according to the present embodiment.

FIG. 3 is a flowchart illustrating processes performed in first to third examples of a first embodiment.

FIG. 4 is a diagram illustrating low beam light distribution patterns emitted by a right lamp unit and left lamp unit in the first example of the first embodiment.

FIG. 5 is a diagram illustrating low beam light distribution patterns emitted by the right lamp unit and left lamp unit in the second example of the first embodiment.

FIG. 6 is a diagram illustrating light distribution patterns emitted by the right lamp unit and left lamp unit in the third example of the first embodiment.

FIG. 7 is a flowchart illustrating processes performed in fourth to sixth examples of the first embodiment.

FIG. 8 is a diagram illustrating low beam light distribution patterns emitted by the respective lamp units in the fourth example of the first embodiment.

FIG. 9 is a diagram illustrating low beam light distribution patterns emitted by the respective lamp units in the fourth example of the first embodiment.

FIG. 10 is a diagram illustrating low beam light distribution patterns emitted by the respective lamp units in the fourth example of the first embodiment.

FIG. 11 is a diagram illustrating low beam light distribution patterns emitted by the respective lamp units in the fifth example of the first embodiment.

FIG. 12 is a diagram illustrating light distribution patterns emitted by the respective lamp units in the sixth example of the first embodiment.

FIG. 13 is a flowchart illustrating processes performed in a first example of a second embodiment.

FIG. 14 is a diagram illustrating an ADB light distribution pattern and a low beam light distribution pattern emitted by the right lamp unit in the first example of the second embodiment.

FIG. 15 is a diagram illustrating an ADB light distribution pattern and a low beam light distribution pattern emitted by the right lamp unit when a vehicle is traveling in the right lane in the first example of the second embodiment.

FIG. 16 is a flowchart illustrating processes performed in a second example of the second embodiment.

FIG. 17 is a diagram illustrating an ADB light distribution pattern and a low beam light distribution pattern emitted by the right lamp unit and an ADB light distribution pattern and a low beam light distribution pattern emitted by the left lamp unit in the second example of the second embodiment.

FIG. 18 is a diagram illustrating an ADB light distribution pattern and a low beam light distribution pattern emitted by the right lamp unit and an ADB light distribution pattern and a low beam light distribution pattern emitted by the left lamp unit when a vehicle is traveling in the right lane in the second example of the second embodiment.

### DETAILED DESCRIPTION

In the following detailed description, reference is made to the accompanying drawings, which form a part thereof. The illustrative embodiments described in the detailed description, drawings, and claims are not meant to be limiting. Other embodiments may be utilized, and other changes may be made without departing from the spirit or scope of the subject matter presented here.

Hereinafter, the present embodiment will be described with reference to the drawings. The dimensions of each member illustrated in these drawings may differ from the actual dimensions of each member for the convenience of description.

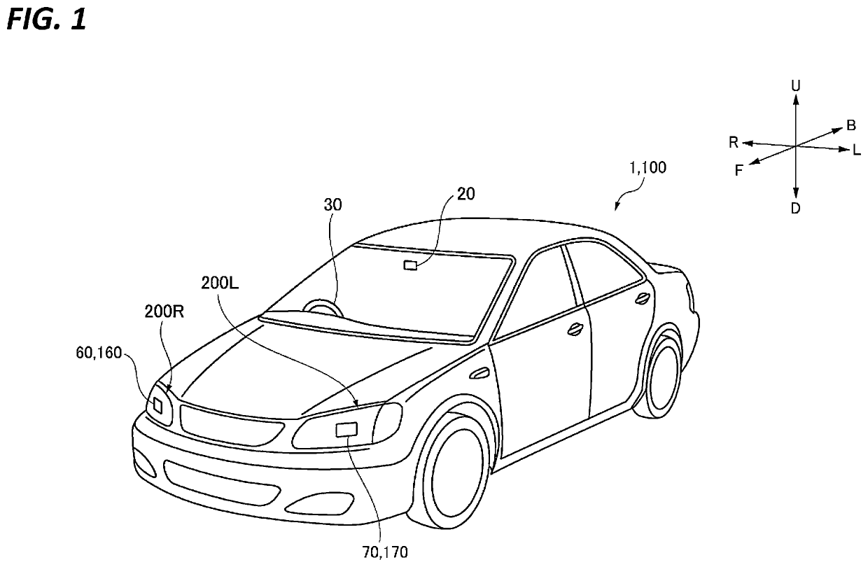

Further, in the description of the present embodiment, terms “left-right direction,” “up-down direction (vertical direction),” and “front-back direction” may be appropriately mentioned for the convenience of description. These directions are relative directions set for a vehicle 1 illustrated in FIG. 1. Here, the “left-right direction” includes both the “leftward direction” and the “rightward direction” and also refers to the width direction of the vehicle 1. The “up-down direction” includes both the “upward direction” and the “downward direction.” The “front-back direction” includes both the “forward direction” and the “backward direction.” The front-back direction is perpendicular to both the left-right direction and the up-down direction. In each drawing, the reference character U indicates the upward direction. The reference character D indicates the downward direction. The reference character F indicates the forward direction. The reference character B indicates the backward direction. The reference character L indicates the leftward direction. The reference character R indicates the rightward direction.

### FIRST EMBODIMENT

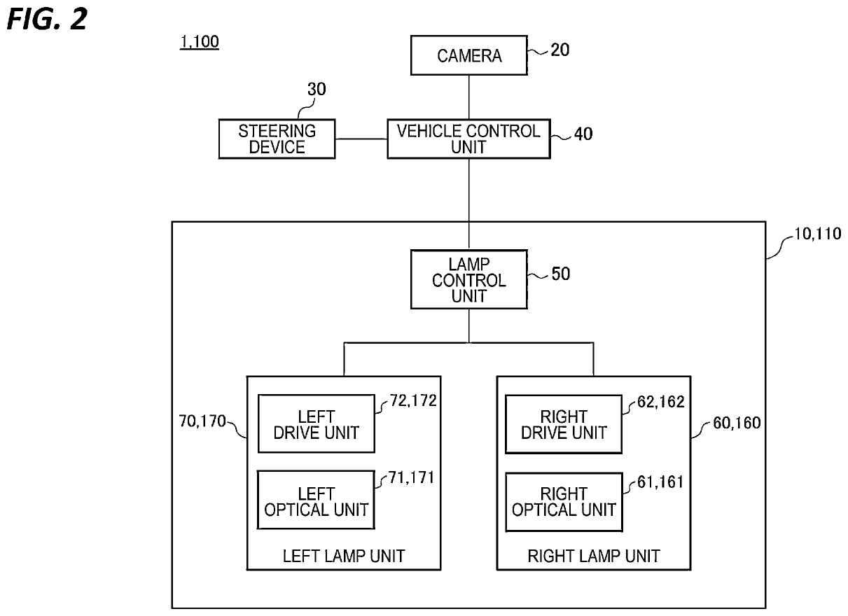

First, a vehicle lamp 10 according to the present embodiment will be described below with reference to FIGS. 1 and 2. FIG. 1 is a perspective view of the vehicle 1 equipped with the vehicle lamp 10. FIG. 2 is a block diagram of a system configuration including the vehicle lamp 10. The vehicle 1 is, for example, a vehicle (automobile) capable of traveling in a manual driving mode and/or an automatic driving mode.

As illustrated in FIGS. 1 and 2, the vehicle 1 includes the vehicle lamp 10, a camera 20, a steering device 30, and a vehicle control unit 40. As illustrated in FIGS. 1 and 2, the vehicle lamp 10 includes a lamp control unit 50, a right lamp unit 60 located on the right side of the vehicle 1, and a left lamp unit 70 located on the left side of the vehicle 1. As illustrated in FIG. 1, the right lamp unit 60 is arranged inside a lamp chamber of a right headlamp 200R. The left lamp unit 70 is arranged inside a lamp chamber of a left headlamp 200L. The right lamp unit 60 may also be provided separately from the right headlamp 200R. The left lamp unit 70 may also be provided separately from the left headlamp 200L. The camera 20 is positioned, for example, near a front windshield. The camera 20 is positioned between the right lamp unit 60 and the left lamp unit 70 in the vehicle width direction (left-right direction in FIG. 1) of the vehicle 1. The steering device 30 is, for example, provided in the interior of the vehicle 1.

The right lamp unit 60 includes a lamp body (not illustrated), an outer cover (not illustrated), a right optical unit 61 arranged inside the lamp chamber formed by the lamp body and the outer cover, and a right drive unit 62 arranged inside the lamp chamber. The left lamp unit 70 includes a lamp body (not illustrated), an outer cover (not illustrated), a left optical unit 71 arranged inside the lamp chamber formed by the lamp body and the outer cover, and a left drive unit 72 arranged inside the lamp chamber.

The camera 20 includes, for example, an imaging device such as a charge-coupled device (CCD) or complementary MOS (CMOS). The camera 20 acquires imaging data by capturing images of the surroundings of the vehicle 1 (e.g., an area in front of the vehicle 1). The camera 20 outputs the imaging data to the vehicle control unit 40.

The steering device 30 includes, for example, a steering wheel, a shaft, and a rack and pinion mechanism. When the steering wheel is rotated clockwise or counterclockwise, the steering device 30 transmits the rotation of the steering wheel to the rack and pinion mechanism through the shaft, thereby changing the direction of wheels to the left or right based on the rotation direction of the steering wheel. When the steering device 30 is operated to the right during the traveling of the vehicle 1, the vehicle 1 moves to the right. When the steering device 30 is operated to the left during the traveling of the vehicle 1, the vehicle 1 moves to the left.

The vehicle control unit 40 is configured to control the traveling of the vehicle 1. The vehicle control unit 40 may be configured to determine the surrounding environment of the vehicle 1 based on surrounding environment information and to transmit the determined results to the lamp control unit 50. The vehicle control unit 40 is constituted with, for example, at least one electronic control unit (ECU). The electronic control unit includes, for example, a computer system including one or more processors and one or more memories as well as an electronic circuit including active elements such as transistors and passive elements.

The vehicle control unit 40 is configured to analyze the imaging data output from the camera 20. The vehicle control unit 40 detects surrounding environment information indicating the surrounding environment of the vehicle 1 from the imaging data and transmits the detected surrounding environment information to the lamp control unit 50. The surrounding environment information includes, for example, position information for a target object (such as an oncoming vehicle, a preceding vehicle, or a traffic sign/a road sign) located in front of the vehicle 1, and type information for the target object. The position information is, for example, an angular coordinate indicating the azimuth of the target object as seen from the vehicle 1. The vehicle control unit 40 may identify the type of the target object and generate type information by analyzing, for example, light emitted from or reflected by the target object. The vehicle control unit 40 may also identify the type of the target object and generate type information, for example, based on changes in the distance between the vehicle 1 and the target object. The vehicle control unit 40 may also identify the type of the target object and generate type information based on a combination of the analysis results of light emitted from or reflected by the target object and changes in the distance between the vehicle 1 and the target object.

The lamp control unit 50 may have the same hardware configuration as that of the vehicle control unit 40. The lamp control unit 50 is configured to control the right lamp unit 60 and the left lamp unit 70 based on the surrounding environment information received from the vehicle control unit 40.

The lamp control unit 50 stores first emission area information related to the emission area of the right optical unit 61 provided in the right lamp unit 60. The first emission area information indicates the area to which light is emitted from the right optical unit 61 when the vehicle 1 is traveling straight and no target object is present in front of the vehicle 1. In the present embodiment, the first emission direction of the right optical unit 61 when no target object is present in front of the vehicle 1 is referred to as the “first reference direction.” Further, the lamp control unit 50 stores second emission area information related to the emission area of the left optical unit 71 provided in the left lamp unit 70. The second emission area information indicates the area to which light is emitted from the left optical unit 71 when the vehicle 1 is traveling straight and no target object is present in front of the vehicle 1. In the present embodiment, the second emission direction of the left optical unit 71 when no target object is present in front of the vehicle 1 is referred to as the “second reference direction.”

The lamp control unit 50 is configured to displace the first emission direction of the right optical unit 61 by a first movement amount by driving the right drive unit 62. Furthermore, the lamp control unit 50 is configured to calculate the first movement amount of the first emission direction in the up-down direction based on the position information for the target object located in front of the vehicle 1 and the first emission area information. Further, the lamp control unit 50 is configured to calculate the first movement amount of the first emission direction in the up-down direction based on the type information for the target object located in front of the vehicle 1 and the first emission area information. The lamp control unit 50 may also displace the second emission direction of the left optical unit 71 by a second movement amount by driving the left drive unit 72. Furthermore, the lamp control unit 50 is configured to calculate the second movement amount of the second emission direction in the up-down direction based on the position information for the target object located in front of the vehicle 1 and the second emission area information. Further, the lamp control unit 50 is configured to calculate the second movement amount of the second emission direction in the up-down direction based on the type information for the target object located in front of the vehicle 1 and the second emission area information. In the present embodiment, the lamp control unit 50 calculates, as the first movement amount, an angle by which the first emission direction is displaced from the first reference direction, and calculates, as the second movement amount, an angle by which the second emission direction is displaced from the second reference direction. Further, in the present embodiment, the first reference direction and the second reference direction are defined as 0 degrees. This 0 degree reference direction may be aligned with the horizontal direction, or may be set to a predetermined reference angle different from the horizontal direction. For example, when the first emission direction and the second emission direction are moved upward from the first reference direction and the second reference direction, the first movement amount and the second movement amount are positive values (angles). When the first emission direction and the second emission direction are moved downward from the first reference direction and the second reference direction, the first movement amount and the second movement amount are negative values (angles). The absolute value of the first movement amount and the absolute value of the second movement amount may be within the range of 0 degrees to 3 degrees.

The right optical unit 61 is configured to emit at least a low beam light distribution pattern. The right optical unit 61 includes, for example, a low beam lamp. The right optical unit 61 may also be configured to emit not only a low beam light distribution pattern but also an adaptive driving beam (ADB) light distribution pattern. In this case, the right optical unit 61 includes a low beam lamp and an ADB high beam lamp. The ADB high beam lamp emits an ADB light distribution pattern to an area including a higher position than the low beam light distribution pattern. The ADB light distribution pattern is a type of high beam light distribution pattern that does not emit light to areas where preceding vehicles or oncoming vehicles are present and that varies a non-emission area based on the presence or absence and positions of preceding vehicles or oncoming vehicles. The right optical unit 61 includes, for example, at least one light source and a projection lens for projecting light emitted from the light source to a forward area of the vehicle 1. The light source 71 may be constituted with, for example, light emitting diodes (LEDs) or laser diodes (LDs). When the right optical unit 61 includes an ADB high beam lamp, the light source may be constituted with, for example, micro LEDs. The projection lens 73 is, for example, an aspherical lens with a convex front surface and a flat rear surface. The projection lens 73 is made of a light transmitting material, for example, a transparent resin such as acryl.

The right optical unit 61 may be constituted with, for example, at least one light source, a drive mirror, and an optical system including a lens, a mirror, and similar components. The drive mirror may be configured with a digital mirror device (DMD) such as a micro electro mechanical system (MEMS) mirror, or a rotating blade mirror.

The right drive unit 62 is, for example, a leveling actuator. The right drive unit 62 includes, for example, a motor serving as a drive source and a screw that rotates when the motor is driven. The screw included in the right drive unit 62 is, for example, screwed into the right optical unit 61. When the right drive unit 62 operates, the right optical unit 61 tilts in the up-down direction. As such, the right drive unit 62 may displace the orientation of the right optical unit 61 in the up-down direction.

The left optical unit 71 may have the same configuration as that of the right optical unit 61. However, the left optical unit 71 may be constituted with, for example, at least one light source, a drive mirror, and an optical system including a lens, a mirror, and similar components. The left optical unit 71 is configured to emit at least a low beam light distribution pattern. The left optical unit 71 includes, for example, a low beam lamp. The left optical unit 71 may also be configured to emit not only a low beam light distribution pattern but also an ADB light distribution pattern. In this case, the left optical unit 71 includes a low beam lamp and an ADB high beam lamp.

The left drive unit 72 is, for example, a leveling actuator. The left drive unit 72 may have the same configuration as that of the right drive unit 62. The left drive unit 72 may tilt the left optical unit 71 in the up-down direction based on the same principle as the right drive unit 62. As such, the left drive unit 72 may displace the orientation of the left optical unit 71 in the up-down direction.

### First Example of First Embodiment

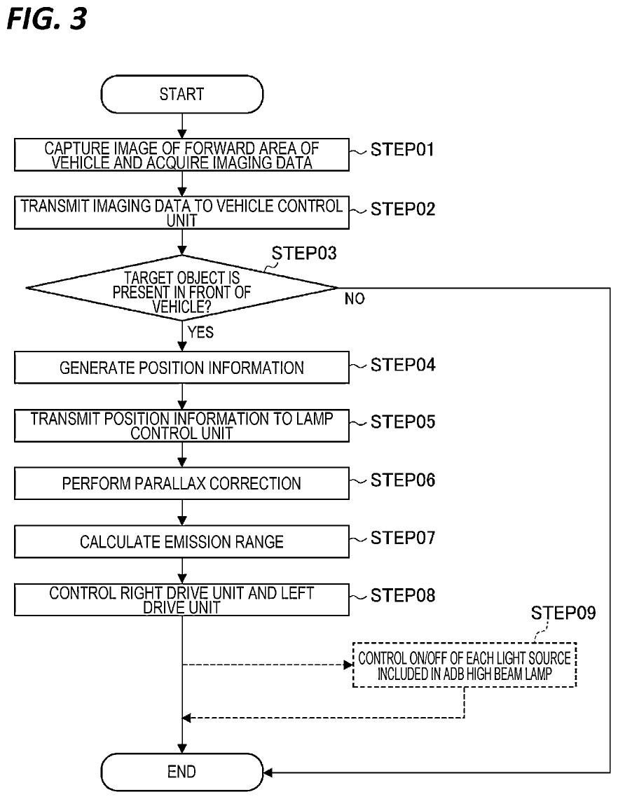

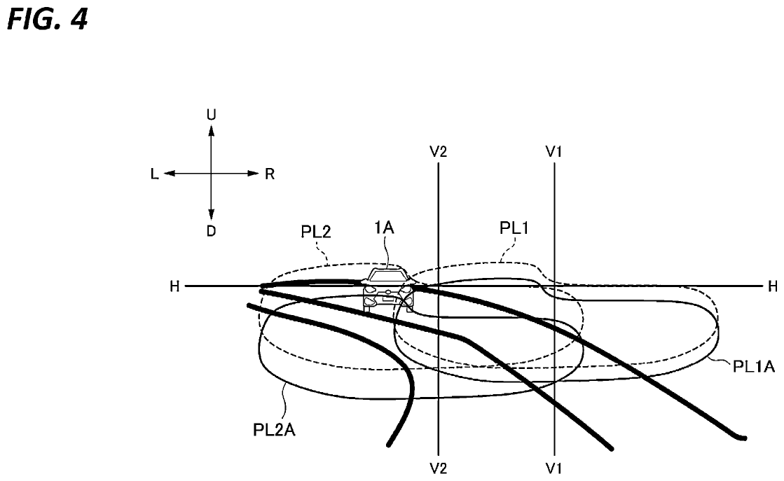

Next, low beam light distribution patterns PL1A and PL2A emitted in this example will be described with reference to FIGS. 3 and 4. FIG. 3 is a flowchart illustrating processes performed in this example. FIG. 4 is a diagram illustrating the low beam light distribution patterns PL1A and PL2A emitted by the right lamp unit 60 and the left lamp unit 70 in the first example of the first embodiment. FIG. 4 illustrates the V1-V1 line indicating the vertical direction (up-down direction in FIG. 4) at the emission range center of the right lamp unit 60, the V2-V2 line indicating the vertical direction at the emission range center of the left lamp unit 70, and the H-H line perpendicular to both the V1-V1 line and the V2-V2 line and extending in the horizontal direction (left-right direction in FIG. 4).

In this example, a case where the vehicle 1 is traveling in the left lane will be described. Further, in this example, it is assumed that the vehicle 1 is traveling on a level road with no gradient, and the first emission direction and second emission direction in the initial state are the first reference direction and second reference direction, respectively. In this example, the heights of the first reference direction and second reference direction are aligned with the H-H line. Further, as illustrated in FIG. 4, in this example, the vehicle 1 is approaching a left-curving road, and an oncoming vehicle (an example of a target object) 1A is present in front of the vehicle 1. As illustrated in FIG. 4, the oncoming vehicle 1A is traveling in the opposing lane (right lane) but is on the vehicle own lane side (left side in FIG. 4) of the left-right direction center in front of the vehicle 1. The low beam light distribution patterns PL1, PL1A, PL2 and PL2A illustrated in FIG. 4 are projections on a virtual vertical screen at a predetermined position in front of the vehicle 1 (e.g., position 15 to 20 meters ahead of the vehicle 1).

As illustrated in FIG. 3, the camera 20 captures images of a forward area of the vehicle 1 and acquires imaging data related to the forward area (STEP01). The camera 20 transmits the imaging data to the vehicle control unit 40 (STEP02).

The vehicle control unit 40 analyzes the imaging data to determine whether a target object is present in front of the vehicle 1 (STEP03). When the vehicle control unit 40 determines that no target object is present in front of the vehicle 1 (NO in STEP03), the vehicle control unit 40 terminates the process. When the vehicle control unit 40 determines that a target object is present in front of the vehicle 1 (YES in STEP03), the vehicle control unit 40 generates position information for the target object from the imaging data (STEP04). In this example, since the oncoming vehicle 1A is present in front of the vehicle 1, the vehicle control unit 40 generates position information for the oncoming vehicle 1A from the imaging data. The position information for the oncoming vehicle 1A is, for example, an angular coordinate indicating the azimuth of the oncoming vehicle 1A as seen from the vehicle 1. The vehicle control unit 40 transmits the position information for the oncoming vehicle 1A to the lamp control unit 50 (STEP05).

As illustrated in FIG. 1, the installation positions of the respective lamp units (right lamp unit 60 and left lamp unit 70) in the vehicle 1 are different from the installation position of the camera 20. This results in a misalignment (parallax) between the respective emission directions of the respective lamp units (first emission direction and second emission direction) and the imaging direction of the camera 20. Therefore, as illustrated in FIG. 3, when receiving the position information for the oncoming vehicle 1A from the vehicle control unit 40, the lamp control unit 50 performs parallax correction on the position information (STEP06). By performing parallax correction, the lamp control unit 50 generates first position information for the oncoming vehicle 1A parallax-corrected on the first emission direction and second position information for the oncoming vehicle 1A parallax-corrected on the second emission direction.

The lamp control unit 50 calculates the emission range of the right lamp unit 60 based on the first position information and the first emission area information, and calculates the emission range of the left lamp unit 70 based on the second position information and the second emission area information (STEP07). The lamp control unit 50 generates emission range information by calculating the emission range of the right lamp unit 60 and the emission range of the left lamp unit 70. Further, at this time, the lamp control unit 50 calculates the first movement amount of the first emission direction in the up-down direction based on the first position information and the first emission area information. The lamp control unit 50 calculates the second movement amount of the second emission direction in the up-down direction based on the second position information and the second emission area information.

Here, referring to FIG. 4, the low beam light distribution pattern PL1 formed when light is emitted from the right lamp unit 60 to the first reference direction and the low beam light distribution pattern PL2 formed when light is emitted from the left lamp unit 70 to the second reference direction will be described. The low beam light distribution pattern PL1 and the low beam light distribution pattern PL2 are drawn by dashed lines in FIG. 4. In the case illustrated in FIG. 4, the low beam light distribution patterns PL1 and PL2 are emitted to areas including a headlamp of the oncoming vehicle 1A. In the present disclosure, in order to prevent such emission, the vehicle lamp 10 displaces the emission range of the low beam light distribution pattern based on the position of the target object. As illustrated in FIG. 4, the range where the low beam light distribution pattern PL1 overlaps with the oncoming vehicle 1A in the up-down direction is smaller than the range where the low beam light distribution pattern PL2 overlaps with the oncoming vehicle 1A. Thus, the distance from the upper end of the low beam light distribution pattern PL1 to the lower end of the headlamp of the oncoming vehicle 1A within the range where the low beam light distribution pattern PL1 overlaps with the oncoming vehicle 1A is shorter than the distance from the upper end of the low beam light distribution pattern PL2 to the lower end of the headlamp of the oncoming vehicle 1A within the range where the low beam light distribution pattern PL2 overlaps with the oncoming vehicle 1A. Therefore, glare may be prevented even with a smaller absolute value of the first movement amount than the absolute value of the second movement amount. In this example, for the right lamp unit 60, the lamp control unit 50 determines that the first emission direction needs to be moved 0.2 degrees downward, and calculates the first movement amount as −0.2 degrees. Further, for the left lamp unit 70, the lamp control unit 50 determines that the second emission direction needs to be moved 1 degree downward, and calculates the second movement amount as −1 degree.

As illustrated in FIG. 3, after calculating the first movement amount and second movement amount, the lamp control unit 50 controls the right drive unit 62 to displace the first emission direction by the first movement amount, and controls the left drive unit 72 to displace the second emission direction by the second movement amount (STEP08). In this example, since the first movement amount is −0.2 degrees and the second movement amount is −1 degree, the lamp control unit 50 moves the orientation of the right optical unit 61 downward by 0.2 degrees, and moves the orientation of the left optical unit 71 downward by 1 degree. As a result, the first emission direction is inclined 0.2 degrees downward from the first reference direction, and the second emission direction is inclined 1 degree downward from the second reference direction. As such, the lamp control unit 50 individually controls the right drive unit 62 and the left drive unit 72 based on the position of the oncoming vehicle 1A, and as a result, individually displaces the first emission direction and the second emission direction downward. The processes from STEP01 to STEP08 are repeatedly executed while the vehicle 1 is traveling. In other words, while the vehicle 1 is traveling, the emission range of the low beam light distribution pattern emitted from the vehicle lamp 10 is controlled to change appropriately based on the presence or absence of the target object or the position of the target object.

Here, referring to FIG. 4, the low beam light distribution patterns PL1A and PL2A, which are emitted when the orientation of the right optical unit 61 is moved 0.2 degrees downward from the first reference direction and the orientation of the left optical unit 71 is moved 1 degree downward from the second reference direction, will be described. The low beam light distribution pattern PL1A and the low beam light distribution pattern PL2A are drawn by solid lines in FIG. 4. As illustrated in FIG. 4, the low beam light distribution pattern PL1A is emitted downward of the low beam light distribution pattern PL1, and the low beam light distribution pattern PL2A is emitted downward of the low beam light distribution pattern PL2. Further, since the absolute value of the first movement amount is smaller than the absolute value of the second movement amount, the downward movement amount from the low beam light distribution pattern PL1 to the low beam light distribution pattern PL1A is smaller than the downward movement amount from the low beam light distribution pattern PL2 to the low beam light distribution pattern PL2A. However, since both the ranges where the low beam light distribution patterns PL1A and PL2A overlap with the oncoming vehicle 1A are below the headlamp of the oncoming vehicle 1A in the up-down direction, glare is prevented. Further, although greater downward movement amounts of the first emission direction and second emission direction may deteriorate long-distance visibility, the vehicle lamp 10 moves the first emission direction and second emission direction downward by the amount necessary to prevent glare, thereby avoiding any unnecessary deterioration in long-distance visibility.

According to the vehicle lamp 10 having the above configuration, the lamp control unit 50 individually displaces the first emission direction of the low beam light distribution pattern emitted by the right optical unit 61 and the second emission direction of the low beam light distribution pattern emitted by the left optical unit 71 in the up-down direction, based on the position of the oncoming vehicle 1A. In other words, the vehicle lamp 10 may individually displace the first emission direction and the second emission direction in the up-down direction, thereby preventing glare while avoiding any unnecessary deterioration in long-distance visibility for the vehicle 1. In this way, the vehicle lamp 10 may achieve both the maintenance of long-distance visibility for the vehicle and the prevention of glare.

Further, according to the vehicle lamp 10 having the above configuration, the first movement amount is calculated based on the position of the oncoming vehicle 1A and the first emission area information, and the second movement amount is calculated based on the position of the oncoming vehicle 1A and the second emission area information. Then, the lamp control unit 50 displaces the first emission direction by the first movement amount and displaces the second emission direction by the second movement amount. In other words, the movement amount of each emission direction is calculated based on the position of the oncoming vehicle 1A and the emission area information for each optical unit (right optical unit 61 and left optical unit 71), so that each of the first emission direction and the second emission direction may be displaced by an appropriate movement amount.

Further, According to the vehicle lamp 10 having the above configuration, the first movement amount is −0.2 degrees, and the second movement amount is −1 degree. In other words, the absolute value of the first movement amount is within the range of 0 degrees to 3 degrees relative to the first reference direction, and the absolute value of the second movement amount is within the range of 0 degrees to 3 degrees relative to the second reference direction. Thus, the vehicle lamp 10 may prevent glare while avoiding any unnecessary deterioration in long-distance visibility for the vehicle.

Further, according to the vehicle lamp 10 having the above configuration, the lamp control unit 50 individually controls the right drive unit 62 that displaces the orientation of the right optical unit 61 in the up-down direction and the left drive unit 72 that displaces the orientation of the left optical unit 71 in the up-down direction, based on the position of the oncoming vehicle 1A. In other words, the lamp control unit 50 individually controls the orientation of the right optical unit 61 and the orientation of the left optical unit 71 in the up-down direction via the right drive unit 62 and the left drive unit 72. As such, the vehicle lamp 10 may individually displace the orientation of the right optical unit 61 and the orientation of the left optical unit 71 in the up-down direction using the right drive unit 62 and the left drive unit 72. Thus, the vehicle lamp 10 may achieve the accurate adjustment of the emission directions of the right optical unit 61 and the left optical unit 71 in the up-down direction.

Further, according to the vehicle lamp 10 having the above configuration, when the oncoming vehicle 1A is on the vehicle own lane side of the left-right direction center in front of the vehicle 1, the lamp control unit 50 individually displaces the first emission direction and second emission direction in the up-down direction based on the position of the oncoming vehicle 1A. Since the cutoff line of the low beam light distribution pattern is located higher on the vehicle own lane side than on the opposing lane side in the left-right direction, there is a risk of the low beam light distribution pattern being emitted to the headlamp of the oncoming vehicle 1A when the oncoming vehicle 1A is on the vehicle own lane side. In such a state where there is a risk of causing glare to the oncoming vehicle 1A, the lamp control unit 50 individually displaces each emission direction in the up-down direction based on the position of the oncoming vehicle 1A. Thus, the vehicle lamp 10 may achieve the prevention of glare while maintaining long-distance visibility for the vehicle.

### Second Example of First Embodiment

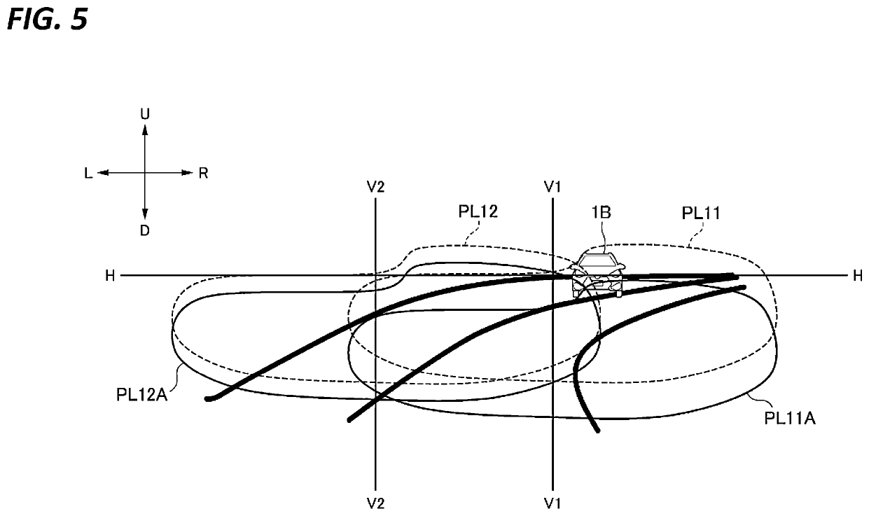

Next, low beam light distribution patterns PL11A and PL12A emitted in this example will be described with reference to FIGS. 3 and 5 This example differs from the first example of the first embodiment in that the vehicle 1 is traveling in the right lane and that the right cutoff line is higher than the left cutoff line in the low beam light distribution patterns PL11, PL12, PL11A and PL12A, but is basically the same as the first example of the first embodiment in all other respects. In this example, the same parts as those in the first example of the first embodiment will not be described as appropriate. In FIG. 5 as well, the same V1-V1, V2-V2 and H-H lines as those in the first example of the first embodiment are illustrated. Further, as illustrated in FIG. 5, in this example, the vehicle 1 is approaching a right-curving road, and an oncoming vehicle 1B is present in front of the vehicle 1. As illustrated in FIG. 5, the oncoming vehicle 1B is traveling in the opposing lane (left lane) but is on the vehicle own lane side (right side in FIG. 5) of the left-right direction center in front of the vehicle 1.

In this example as well, the processes illustrated in FIG. 3 are executed, similarly to the first example of the first embodiment. In this example, STEP01 to STEP06 are the same as in the first example of the first embodiment.

Next, STEP07 will be described. In STEP07 of this example as well, the same process as in STEP07 of the first example of the first embodiment is executed. Here, referring to FIG. 5, the low beam light distribution pattern PL11 formed when light is emitted from the right lamp unit 60 to the first reference direction and the low beam light distribution pattern PL12 formed when light is emitted from the left lamp unit 70 to the second reference direction will be described. The low beam light distribution pattern PL11 and the low beam light distribution pattern PL12 are drawn by dashed lines in FIG. 5. As illustrated in FIG. 5, in the up-down direction, the range where the low beam light distribution pattern PL11 overlaps with the oncoming vehicle 1B is greater than the range where the low beam light distribution pattern PL12 overlaps with the oncoming vehicle 1B. Thus, the distance from the upper end of the low beam light distribution pattern PL11 to the lower end of a headlamp of the oncoming vehicle 1B within the range where the low beam light distribution pattern PL11 overlaps with the oncoming vehicle 1B is longer than the distance from the upper end of the low beam light distribution pattern PL12 to the lower end of the headlamp of the oncoming vehicle 1B within the range where the low beam light distribution pattern PL12 overlaps with the oncoming vehicle 1B. Therefore, glare may be prevented even with a smaller absolute value of the second movement amount than the absolute value of the first movement amount. In this example, for the right lamp unit 60, the lamp control unit 50 determines that the first emission direction needs to be moved 1 degree downward, and calculates the first movement amount as −1 degree. Further, for the left lamp unit 70, the lamp control unit 50 determines that the second emission direction needs to be moved 0.2 degrees downward, and calculates the second movement amount as −0.2 degrees.

Next, STEP08 will be described. In this example, since the first movement amount is −1 degree and the second movement amount is −0.2 degrees, the lamp control unit 50 moves the orientation of the right optical unit 61 downward by 1 degree, and moves the orientation of the left optical unit 71 downward by 0.2 degrees. As a result, the first emission direction is inclined 1 degree downward from the first reference direction, and the second emission direction is inclined 0.2 degrees downward from the second reference direction. In this example as well, the processes from STEP01 to STEP08 are repeatedly executed while the vehicle 1 is traveling.

Here, referring to FIG. 5, the low beam light distribution patterns PL11A and PL12A, which are emitted when the orientation of the right optical unit 61 is moved 1 degree downward from the first reference direction and the orientation of the left optical unit 71 is moved 0.2 degrees downward from the second reference direction, will be described. The low beam light distribution pattern PL11A and the low beam light distribution pattern PL12A are drawn by solid lines in FIG. 5. As illustrated in FIG. 5, the low beam light distribution pattern PL11A is emitted downward of the low beam light distribution pattern PL11, and the low beam light distribution pattern PL12A is emitted downward of the low beam light distribution pattern PL12. Further, since the absolute value of the first movement amount is greater than the absolute value of the second movement amount, the downward movement amount from the low beam light distribution pattern PL11 to the low beam light distribution pattern PL11A is greater than the downward movement amount from the low beam light distribution pattern PL12 to the low beam light distribution pattern PL12A. However, since both the ranges where the low beam light distribution patterns PL11A and PL12A overlap with the oncoming vehicle 1B are below the headlamp of the oncoming vehicle 1B in the up-down direction, glare is prevented. Further, the vehicle lamp 10 moves the first emission direction and the second emission direction only by the amount necessary to prevent glare, thereby avoiding any unnecessary deterioration in long-distance visibility.

In this example as well, the vehicle lamp 10 exerts the same effects as those in the first example of the first embodiment.

### Third Example of First Embodiment

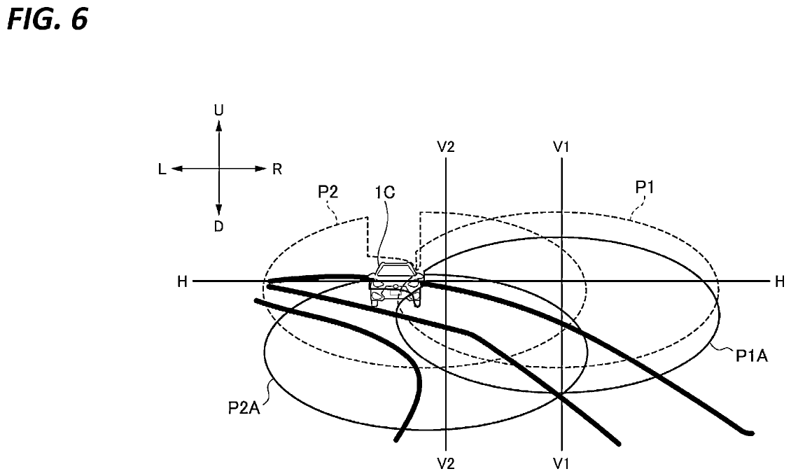

Next, light distribution patterns P1A and P2A emitted in this example will be described with reference to FIGS. 3 and 6. This example differs from the first example of the first embodiment in that the right optical unit 61 and the left optical unit 71 emit not only low beam light distribution patterns but also ADB light distribution patterns and that the processes from STEP01 to STEP09 are executed, but is basically the same as the first example of the first embodiment in all other respects. In this example, the same parts as those in the first example of the first embodiment will not be described as appropriate. In FIG. 6 as well, the same V1-V1, V2-V2, and H-H lines as in the first example of the first embodiment are illustrated. As illustrated in FIG. 6, in this example, the vehicle 1 is approaching a left-curving road, and an oncoming vehicle 1C is present in front of the vehicle 1. As illustrated in FIG. 6, the oncoming vehicle 1C is traveling in the opposing lane (right lane) but is on the vehicle own lane side (left side in FIG. 6) of the left-right direction center in front of the vehicle 1. Further, in this example, the light distribution patterns P1, P1A, P2 and P2A include low beam light distribution patterns and ADB light distribution patterns. The low beam light distribution patterns included in the light distribution patterns P1, P1A, P2 and P2A are the same as the low beam light distribution patterns PL1, PL1A, PL2 and PL2A of the first example of the first embodiment.

In this example, the processes from STEP01 to STEP09 illustrated in FIG. 3 are executed. In this example, STEP01 to STEP09 are the same as in the first example of the first embodiment.

Next, STEP07 will be described. In STEP07 of this example as well, the same process as STEP07 of the first example of the first embodiment is executed. However, the emission range information generated by the lamp control unit 50 in STEP07 includes information for distinguishing between the range where the ADB light distribution pattern needs to be emitted and the range where the ADB light distribution pattern needs not to be emitted.

Here, referring to FIG. 6, the light distribution pattern P1 formed when light is emitted from the right lamp unit 60 to the first reference direction and the light distribution pattern P2 formed when light is emitted from the left lamp unit 70 to the second reference direction will be described. The light distribution pattern P1 and the light distribution pattern P2 are drawn by dashed lines in FIG. 6. In this example, the low beam light distribution patterns included in the light distribution patterns P1 and P2 are the same as the low beam light distribution patterns PL1 and PL2 of the first example of the first embodiment. Thus, since the range where the low beam light distribution pattern included in the light distribution pattern P1 overlaps with the oncoming vehicle 1C is smaller than the range where the low beam light distribution pattern included in the light distribution pattern P2 overlaps with the oncoming vehicle 1C in the up-down direction, the absolute value of the first movement amount is smaller than the absolute value of the second movement amount. The first movement amount and the second movement amount calculated by the lamp control unit 50 in this example are the same as the first movement amount and the second movement amount in the first example of the first embodiment. Since the ADB light distribution pattern is controlled to ensure that, in principle, it is not emitted to an area where an oncoming vehicle is present, the ADB light distribution patterns included in the light distribution patterns P1 and P2 are not emitted to the oncoming vehicle 1C, as illustrated in FIG. 6.

STEP08 of this example is the same as STEP08 of the first example of the first embodiment.

Next, STEP09 will be described. As illustrated in FIG. 3, once STEP08 is executed, the lamp control unit 50 controls the on/off of each light source provided in the ADB high beam lamps based on the emission range information generated in STEP07 (STEP09). As a result, as illustrated in FIG. 6, the ADB light distribution patterns are not emitted to an area where the oncoming vehicle 1C is present. The processes from STEP01 to STEP09 are repeatedly executed while the vehicle 1 is traveling. In other words, while the vehicle 1 is traveling, the emission range of the light distribution pattern emitted from the vehicle lamp 10 is controlled to change appropriately based on the presence or absence of the target object or the position of the target object.

Here, the light distribution patterns P1A and P2A emitted in this example will be described with reference to FIG. 6. The light distribution patterns P1A and P2A each include both the low beam light distribution pattern and the ADB light distribution pattern, but the low beam light distribution pattern is emitted below the headlamp of the oncoming vehicle 1C in the up-down direction, based on the principle described in the first example of the first embodiment. Further, as illustrated in FIG. 6, the ADB light distribution patterns are also not emitted to the area where the oncoming vehicle 1C is present. Thus, in this example as well, the vehicle lamp 10 prevents glare. Further, the vehicle lamp 10 does not cause any unnecessary deterioration in long-distance visibility by moving the first emission direction and the second emission direction only by the amount necessary to prevent glare.

In this example as well, the vehicle lamp 10 exerts the same effects as those in the first example of the first embodiment.

Further, according to the vehicle lamp 10 having the above configuration, the right optical unit 61 and the left optical unit 71 may emit not only low beam light distribution patterns but also ADB light distribution patterns. The ADB high beam lamp, which emits light to an area including a higher position than the low beam light distribution pattern, is more prone to causing glare compared to the low beam lamp. However, the vehicle lamp 10 including the ADB high beam lamp may also prevent glare while maintaining good long-distance visibility for the vehicle through the control described in the embodiment.

### Fourth Example of First Embodiment

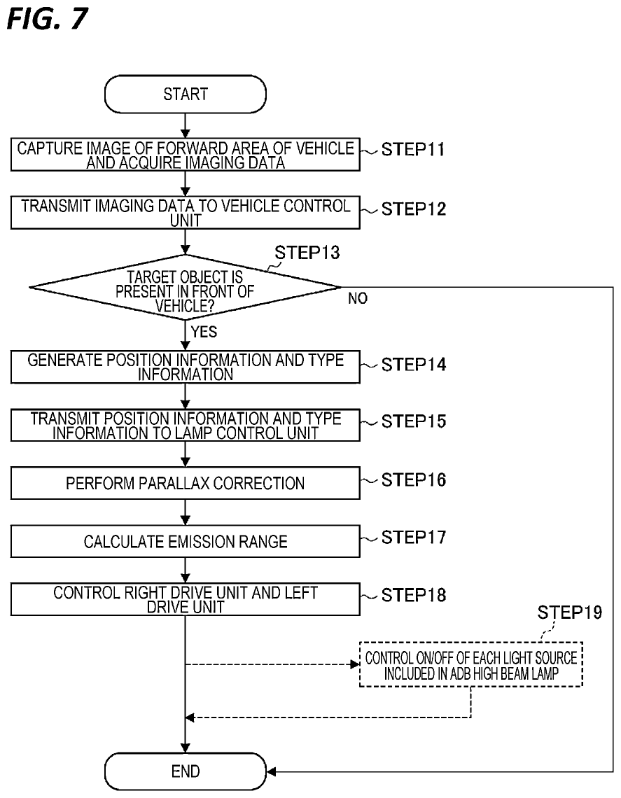

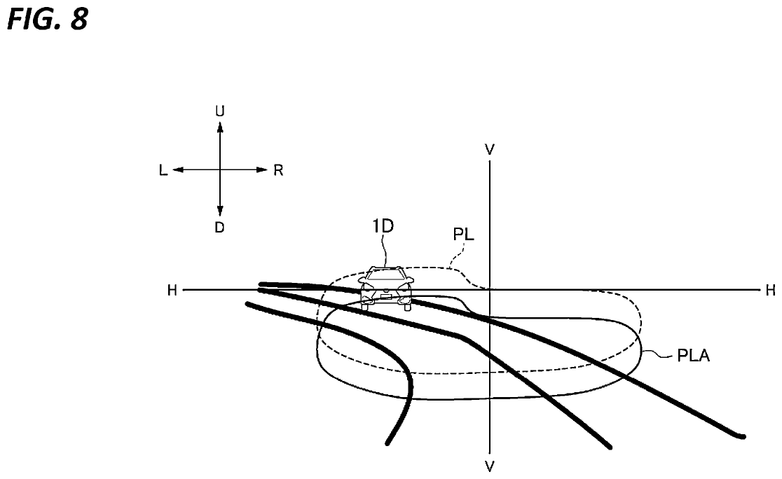

Next, a low beam light distribution pattern PLA emitted in this example will be described with reference to FIGS. 7 and 8. FIG. 7 is a flowchart illustrating processes performed in this example. FIG. 8 is a diagram illustrating low beam light distribution patterns PL and PLA that may be emitted by the respective lamp units in this example. In this example, the right optical unit 61 emits the low beam light distribution pattern PLA. Since the low beam light distribution pattern emitted by the left lamp unit 70 is the same as the low beam light distribution pattern PLA emitted by the right lamp unit 60, the following description will focus on a case where the right lamp unit 60 emits one low beam light distribution pattern PLA, and the description of the left lamp unit 70 will be omitted. Further, FIG. 8 illustrates the V-V line indicating the vertical direction (up-down direction in FIG. 8) at the emission range center of the right lamp unit 60 and the H-H line perpendicular to the V-V line and extending in the horizontal direction (left-right direction in FIG. 8). The V-V line represents an example of the left-right direction center in front of the vehicle 1.

This example describes a case where the vehicle 1 is traveling in the left lane. Further, in this example, it is assumed that the vehicle 1 is traveling on a level road with no gradient and the first emission direction in the initial state is the first reference direction. In this example, the height of the first reference direction is aligned with the H-H line. Further, as illustrated in FIG. 8, in this example, the vehicle 1 is approaching a left-curving road, and an oncoming vehicle (an example of a target object) 1D is present in front of the vehicle 1. As illustrated in FIG. 8, the oncoming vehicle 1D is traveling in the opposing lane (right lane) but is on the vehicle own lane side (left side in FIG. 8) of the V-V line (the left-right direction center in front of the vehicle 1). The low beam light distribution patterns PL and PLA illustrated in FIG. 8 are projections on a virtual vertical screen at a predetermined position in front of the vehicle 1 (e.g., position 25 meters ahead of the vehicle 1). Further, in this example, the vehicle 1 is traveling at a speed of 65 km/h, while the oncoming vehicle 1D is traveling at a speed of 60 km/h. In this example, the same parts as those in the first example of the first embodiment will not be described as appropriate.

As illustrated in FIG. 7, STEP11 and STEP12 are the same as STEP01 and STEP02 in the first example of the first embodiment.

The vehicle control unit 40 analyzes the imaging data to determine whether a target object is present in front of the vehicle 1 (STEP13). When the vehicle control unit 40 determines that no target object is present in front of the vehicle 1 (NO in STEP13), the vehicle control unit 40 terminates the process. When the vehicle control unit 40 determines that a target object is present in front of the vehicle 1 (YES in STEP13), the vehicle control unit 40 generates position information and type information of the target object from the imaging data (STEP14). In this example, since the oncoming vehicle 1D is present in front of the vehicle 1, the vehicle control unit 40 generates position information and type information for the oncoming vehicle 1D from the imaging data. The position information for the oncoming vehicle 1D is, for example, an angular coordinate indicating the azimuth of the oncoming vehicle 1D as seen from the vehicle 1. Further, the type information for the oncoming vehicle 1D indicates that the oncoming vehicle 1D is an oncoming vehicle relative to the vehicle 1.

In this example, the vehicle control unit 40 identifies the type of the oncoming vehicle 1D and generates type information based on the analysis results of light emitted from the oncoming vehicle 1D and changes in the distance between the vehicle 1 and the oncoming vehicle 1D. For example, when light generated from the target object is white, the vehicle control unit 40 determines that the target object is an oncoming vehicle. For example, when light generated by the target object is red, the vehicle control unit 40 determines that the target object is a preceding vehicle. For example, when light emitted from the vehicle lamp 10 is reflected by the target object via retro-reflection, the vehicle control unit 40 determines that the target object is a traffic sign (e.g., a road sign). Further, for example, when the vehicle 1 is approaching the target object significantly faster than the speed of the vehicle 1, the vehicle control unit 40 determines that the target object is an oncoming vehicle. For example, when the vehicle 1 is approaching or moving away from the target object at a slower speed or slightly faster speed than the speed of the vehicle 1, the vehicle control unit 40 determines that the target object is a preceding vehicle. When the vehicle 1 is approaching the target object at the same speed as the speed of the vehicle 1, the vehicle control unit 40 determines that the target object is a traffic sign. In this example, the vehicle control unit 40 determines that the target object is an oncoming vehicle based on the facts that light generated from the target object is white and that the vehicle 1 is approaching the target object at a speed significantly faster than the speed of the vehicle 1 (125 km/h in this case). The vehicle control unit 40 transmits the position information and type information for the oncoming vehicle 1D to the lamp control unit 50 (STEP15).

As illustrated in FIG. 1, since the installation positions of the respective lamp units (right lamp unit 60 and left lamp unit 70) in the vehicle 1 are different from the installation position of the camera 20, there is a misalignment (parallax) between the emission directions of the respective lamp units and the imaging direction of the camera 20. Therefore, as illustrated in FIG. 7, when receiving the position information for the oncoming vehicle 1D from the vehicle control unit 40, the lamp control unit 50 performs parallax correction on the position information (STEP16). For example, the lamp control unit 50 generates first position information for the oncoming vehicle 1D parallax-corrected on the first emission direction by performing the parallax correction.

The lamp control unit 50 calculates the emission range of the right lamp unit 60 based on the type information and the first emission area information (STEP17) After calculating the emission range of the right lamp unit 60, the lamp control unit 50 generates emission range information. Further, at this time, the lamp control unit 50 calculates the first movement amount of the first emission direction in the up-down direction based on the type information and the first emission area information. Since the target object in this example is the oncoming vehicle 1D, the lamp control unit 50 determines, for the right lamp unit 60, that the first emission direction needs to be moved 1 degree downward, and calculates the first movement amount as −1 degree. The lamp control unit 50 also calculates the second movement amount as −1 degree.

After calculating the first movement amount, the lamp control unit 50 controls the right drive unit 62 to displace the first emission direction by the first movement amount (STEP18). In STEP18, the lamp control unit 50 also controls the left drive unit 72 in the same manner as the control of the right drive unit 62. In this example, since the target object is the oncoming vehicle 1D, the lamp control unit 50 controls the right drive unit 62 to displace the first emission direction 1 degree downward. As a result, the first emission direction is inclined 1 degree downward from the first reference direction. As such, the lamp control unit 50 controls the right drive unit 62 based on the type of the oncoming vehicle 1D, and as a result, displaces the first emission direction downward. Since the lamp control unit 50 also controls the left drive unit 72 in the same manner as the control of the right drive unit 62 in STEP18, the second emission direction is inclined 1 degree downward from the second reference direction.

Here, referring to FIG. 8, the low beam light distribution pattern PL formed when light is emitted from the right lamp unit 60 to the first reference direction and the low beam light distribution pattern PLA emitted when the orientation of the right optical unit 61 is moved 1 degree downward from the first reference direction will be described. In FIG. 8, the low beam light distribution pattern PL is drawn by a dashed line, and the low beam light distribution pattern PLA is drawn by a solid line. In the case illustrated in FIG. 8, the low beam light distribution pattern PL is emitted to an area including a headlamp of the oncoming vehicle 1D. In the present disclosure, in order to prevent such emission, the vehicle lamp 10 displaces the emission range of the low beam light distribution pattern based on the type of the target object. As illustrated in FIG. 8, in the emission of the low beam light distribution pattern PL, the low beam light distribution pattern PL is emitted to an area above the headlamp of the oncoming vehicle 1D in the up-down direction. Therefore, when the low beam light distribution pattern PL is emitted, it causes glare to the oncoming vehicle 1D.

Meanwhile, when the low beam light distribution pattern PLA is emitted, glare is prevented since the low beam light distribution pattern PLA is emitted to an area below the headlamp of the oncoming vehicle 1D. Further, the maximum permissible intensity of light for emission toward an oncoming vehicle is smaller than the maximum permissible intensity of light for emission toward a preceding vehicle. Furthermore, since it becomes easier to prevent glare toward an oncoming vehicle when the emission direction of the low beam light distribution pattern is moved 1 degree downward, in this example, the downward movement amount of the emission direction of the low beam light distribution pattern is set to 1 degree when the target object is an oncoming vehicle.

The processes from STEP11 to STEP18 are repeatedly executed while the vehicle 1 is traveling. In other words, while the vehicle 1 is traveling, the emission range of the low beam light distribution pattern emitted from the vehicle lamp 10 is controlled to change appropriately based on the presence or absence of the target object or the type of the target object.

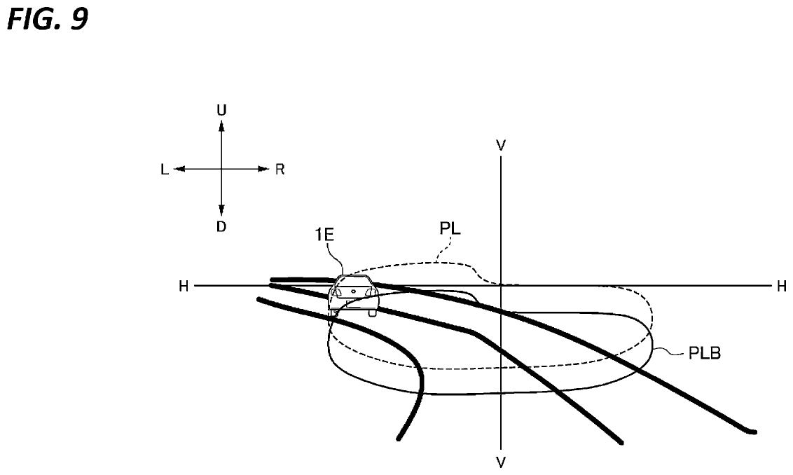

Next, a low beam light distribution pattern PLB emitted when the target object is a preceding vehicle 1E will be described with reference to FIGS. 7 and 9. As illustrated in FIG. 9, the preceding vehicle 1E is traveling in the same lane as the vehicle 1, and therefore, is on the vehicle own lane side (left side in FIG. 9) of the V-V line. Further, the vehicle 1 is traveling at a speed of 65 km/h, and the preceding vehicle 1E is traveling at a speed of 60 km/h.

First, the processes from STEP11 to STEP13 are performed in the same manner as described above.

In STEP14, the vehicle control unit 40 generates position information and type information for the preceding vehicle 1E. The vehicle control unit 40 determines that the target object is a preceding vehicle based on the facts that light generated from the target object is red and that the vehicle 1 is approaching the target object at a slower speed than the speed of the vehicle 1 (5 km/h in this case).

STEP15 and STEP16 are the same as described above.

Next, STEP17 will be described. Since the target object in FIG. 9 is the preceding vehicle 1E, the lamp control unit 50 determines, for the right lamp unit 60, that the first emission direction needs to be moved 0.3 degrees downward, and calculates the first movement amount as −0.3 degrees. The lamp control unit 50 also calculates the second movement amount as −0.3 degrees.

The lamp control unit 50 controls the right drive unit 62 to displace the first emission direction by 0.3 degrees (STEP18). As a result, the first emission direction is inclined 0.3 degrees downward from the first reference direction. Since the lamp control unit 50 also controls the left drive unit 72 in the same manner as the control of the right drive unit 62 in STEP18, the second emission direction is inclined 0.3 degrees downward from the second reference direction.

Here, referring to FIG. 9, the low beam light distribution pattern PL formed when light is emitted from the right lamp unit 60 to the first reference direction and the low beam light distribution pattern PLB emitted when the orientation of the right optical unit 61 is moved 0.3 degrees downward from the first reference direction will be described. In FIG. 9, the low beam light distribution pattern PL is drawn by a dashed line, and the low beam light distribution pattern PLB is drawn by a solid line. As illustrated in FIG. 9, in the emission of the low beam light distribution pattern PL, the low beam light distribution pattern PL is emitted to an area above a tail lamp of the preceding vehicle 1E in the up-down direction. Therefore, when the low beam light distribution pattern PL is emitted, when causes glare to the preceding vehicle 1E.

Meanwhile, when the low beam light distribution pattern PLB is emitted, glare is prevented since the low beam light distribution pattern PLB is emitted to an area below the tail lamp of the preceding vehicle 1E. Since the maximum permissible intensity of light for emission toward a preceding vehicle is greater than the maximum permissible intensity of light for emission toward an oncoming vehicle, the absolute value of the first movement amount when the target object is a preceding vehicle is set to be smaller than the absolute value of the first movement amount when the target object is an oncoming vehicle.

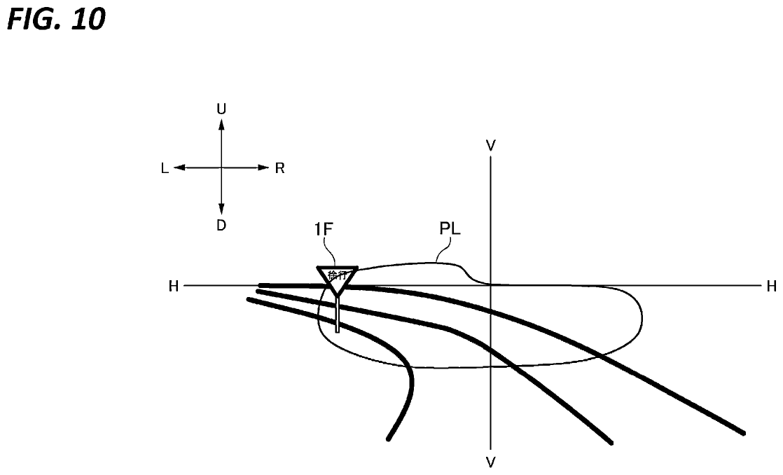

Next, the low beam light distribution pattern PL emitted when the target object is a traffic sign will be described with reference to FIGS. 7 and 10. As illustrated in FIG. 10, since a traffic sign 1F is installed on a road of the right lane, it is on the vehicle own lane side (left side in FIG. 10) of the V-V line. In addition, the vehicle 1 is traveling at a speed of 65 km/h.

First, STEP11 to STEP13 are performed in the same manner as described above.

In STEP 14, the vehicle control unit 40 generates position information and type information for the traffic sign 1F. In this example, the vehicle control unit 40 determines that the target object is a traffic sign based on the facts that light emitted from the vehicle lamp 10 is reflected by the target object by retro-reflection and that the vehicle 1 is approaching the target object at the same speed as the speed of the vehicle 1 (65 km/h in this case).

STEP15 and STEP16 are the same as described above.

STEP17 will be described. Since the target object in FIG. 10 is the traffic sign 1F, the lamp control unit 50 determines, for the right lamp unit 60, that the first emission direction needs not to be moved 0.3 degrees downward, and calculates the first movement amount as 0 degrees. The lamp control unit 50 also calculates the second movement amount as 0 degrees.

The lamp control unit 50 controls the right drive unit 62 to maintain the first emission direction as the first reference direction (STEP18). As a result, the first emission direction is not displaced from the first reference direction. Since the lamp control unit 50 also controls the left drive unit 72 in the same manner as the control of the right drive unit 62 in STEP18, the second emission direction is not displaced from the second reference direction.

Here, referring to FIG. 10, the low beam light distribution pattern PL emitted from the right lamp unit 60 to the first reference direction will be described. As illustrated in FIG. 10, in the emission of the low beam light distribution pattern PL, the low beam light distribution pattern PL is emitted to most of an area of the traffic sign 1F in the up-down direction. However, since glare does not occur when the target object is a traffic sign, there is no need to move the first emission direction downward from the first reference direction, for example, to emit the low beam light distribution pattern PL to the lower side of the traffic sign 1F.

According to the vehicle lamp 10 having the above configuration, the lamp control unit 50 displaces the emission directions of the low beam light distribution patterns emitted by the respective optical units (right optical unit 61 and left optical unit 71) in the up-down direction based on the type of the target object. Since the cutoff line of the low beam light distribution pattern is located higher on the vehicle own lane side than on the opposing lane side in the left-right direction, there is a risk of the low beam light distribution pattern being emitted to the oncoming vehicle 1D when the oncoming vehicle 1D is on the vehicle own lane side. Further, since the maximum permissible intensity of light for emission toward an oncoming vehicle is smaller than the maximum permissible intensity of light for emission toward a preceding vehicle, for example, when the target object is an oncoming vehicle, the need to prevent glare is relatively higher compared to when the target object is a preceding vehicle. Thus, the downward movement amount of the emission direction of the low beam light distribution pattern when the target object is an oncoming vehicle may be set to be greater than the downward movement amount of the emission direction of the low beam light distribution pattern when the target object is a preceding vehicle. Meanwhile, since excessive downward movement of the emission direction of the low beam light distribution pattern deteriorates long-distance visibility in front of the vehicle 1, it is undesirable to move the emission direction of the low beam light distribution pattern downward more than necessary. The vehicle lamp 10 may achieve both the maintenance of long-distance visibility and the prevention of glare by appropriately displacing the emission direction of the low beam light distribution pattern in the up-down direction based on the type of the target object.

Further, according to the vehicle lamp 10 having the above configuration, the type of the object is determined based on the light emitted from or reflected by the target object and changes in the distance between the vehicle 1 and the target object, which enables a simple determination of the type of the target object.

Further, according to the vehicle lamp 10 having the above configuration, the lamp control unit 50 calculates the first movement amount of the first reference direction in the up-down direction, which is the first emission direction when no target object is present in front of the vehicle 1. Since the first movement amount is −1 degree, that is, the absolute value of the first movement amount is within the range of 0 degrees to 3 degrees relative to the first reference direction, glare may be prevented while avoiding any unnecessarily deterioration in long-distance visibility for the vehicle. As such, the vehicle lamp 10 may achieve both the maintenance of long-distance visibility for the vehicle and the prevention of glare.

Further, according to the vehicle lamp 10 having the above configuration, the type of the target object is any one of an oncoming vehicle, a preceding vehicle, and a traffic sign. For example, when the target object is an oncoming vehicle or a preceding ahead, it is necessary to prevent glare while avoiding any unnecessary deterioration in long-distance visibility for the vehicle. However, when the target object is a traffic sign, no glare occurs. As such, the need to prevent glare varies based on the type of the target object. The vehicle lamp 10 may achieve both the maintenance of long-distance visibility and the prevention of glare by appropriately displacing the emission direction of the low beam light distribution pattern in the up-down direction based on the type of the target object.

Further, according to the vehicle lamp 10 having the above configuration, when the target object is an oncoming vehicle or a preceding vehicle, the lamp control unit 50 downwardly displaces the reference directions (first reference direction and second reference direction), which are the emission directions (first emission direction and second emission direction) in the absence of the target object in front of the vehicle 1. Meanwhile, when the target object is a traffic sign, the lamp control unit 50 does not displace the first emission direction and the second emission direction in the up-down direction from the first reference direction and the second reference direction. In other words, when the target object is an oncoming vehicle or a preceding vehicle, the lamp control unit 50 prevents glare by displacing the first emission direction and the second emission direction downward from the first reference direction and the second reference direction. Meanwhile, when the target object is a traffic sign, the lamp control unit 50 does not displace the first emission direction and the second emission direction in the up-down direction from the first reference direction and the second reference direction, thereby avoiding deterioration in long-distance visibility for the vehicle 1. In this way, the vehicle lamp 10 may achieve both the maintenance of long-distance visibility for the vehicle and the prevention of glare by appropriately displacing the first emission direction and the second emission direction in the up-down direction from the first reference direction and the second reference direction based on the type of the target object.

### Fifth Example of First Embodiment

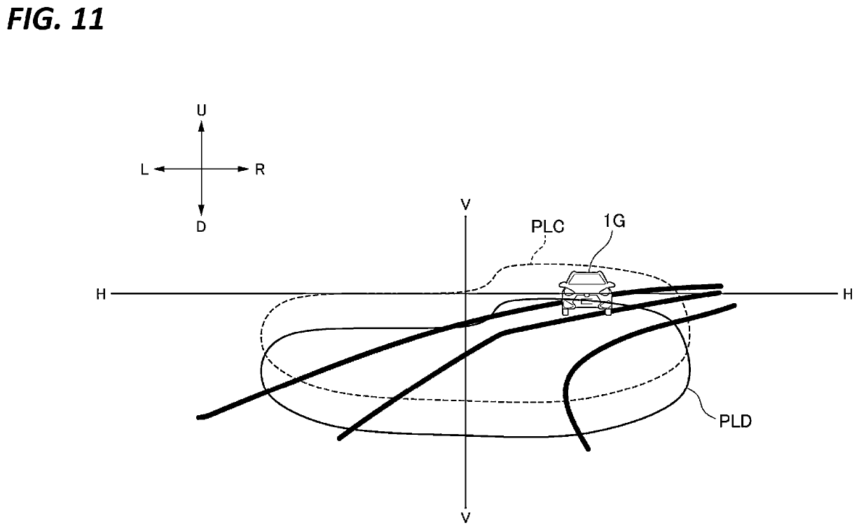

Next, a low beam light distribution pattern PLD emitted in this example will be described with reference to FIGS. 7 and 11. This example differs from the fourth example in that the vehicle 1 is traveling in the right lane and that the right cutoff line is higher than the left cutoff line in the low beam light distribution patterns PLC and PLD, but is basically the same as the fourth example in all other respects. In this example, the same parts as those in the fourth example will not be described as appropriate. In FIG. 11 as well, the same V-V and H-H lines as those in the fourth example are illustrated. As illustrated in FIG. 11, an oncoming vehicle 1G is traveling in the opposing lane (left lane) but is on the vehicle own lane side (right side in FIG. 11) of the V-V line.

In this example as well, the processes illustrated in FIG. 7 are executed, similarly to the fourth example. In this example, STEP11 to STEP18 are the same as in the fourth example.

Here, referring to FIG. 11, the low beam light distribution pattern PLC formed when light is emitted from the right lamp unit 60 to the first reference direction and the low beam light distribution pattern PLD emitted when the orientation of the right optical unit 61 is moved 1 degree downward from the first reference direction will be described. In FIG. 11, the low beam light distribution pattern PLC is drawn by a dashed line, and the low beam light distribution pattern PLD is drawn by a solid line. As illustrated in FIG. 11, in the emission of the low beam light distribution pattern PLC, the low beam light distribution pattern PLC is emitted to an area above a headlamp of the oncoming vehicle 1G in the up-down direction. Therefore, when the low beam light distribution pattern PLC is emitted, it causes glare to the oncoming vehicle 1G.

Meanwhile, when the low beam light distribution pattern PLD is emitted, glare is prevented since the low beam light distribution pattern PLD is emitted to an area below the headlamp of the oncoming vehicle 1G. Further, for the same reasons as in the fourth example, in this example, the downward movement amount of the emission direction of the low beam light distribution pattern when the target object is an oncoming vehicle is set to 1 degree. Thus, the vehicle lamp 10 may displace the first emission direction and the second emission direction by an appropriate movement amount based on the type of the target object, thereby avoiding any unnecessary deterioration in long-distance visibility.

In this example as well, the processes from STEP11 to STEP18 are repeatedly executed while the vehicle 1 is traveling. The process of lowering the emission direction when the target object is a preceding vehicle, and the process of not lowering the emission direction when the target object is a traffic sign, are the same as in the fourth example. In this example as well, the vehicle lamp 10 exerts the same effects as those in the fourth example.

### Fifth Example of First Embodiment

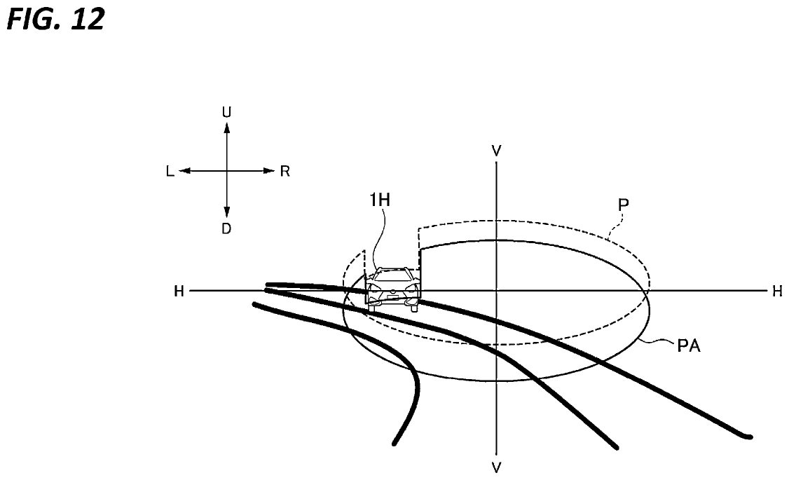

Next, light distribution patterns P and PA emitted in this example will be described with reference to FIGS. 7 and 12. This example differs from the fourth example in that the right optical unit 61 and the left optical unit 71 emit not only low beam light distribution patterns but also ADB light distribution patterns and that the processes from STEP11 to STEP19 are executed, but is basically the same as the fourth example in all other respects. In this example, the same parts as those in the fourth example will not be described as appropriate. In FIG. 12 as well, the same V-V and H-H lines as in the fourth example are illustrated. As illustrated in FIG. 12, an oncoming vehicle 1H is traveling in the opposing lane (right lane) but is on the vehicle own lane side (left side in FIG. 12) of the V-V line. Further, in this example, the light distribution patterns P and PA include both low beam light distribution patterns and ADB light distribution patterns, and the low beam light distribution patterns are the same as the low beam light distribution patterns PL and PLA in the fourth example.

In this example as well, the processes illustrated in FIG. 7 are executed, similarly to the fourth example. STEP11 to STEP16 are the same as in the fourth example.

Next, STEP17 will be described. In STEP17 of this example as well, the same process as in STEP17 of the fourth example is executed. However, the emission range information generated by the lamp control unit 50 in STEP17 includes information for distinguishing between the range where the ADB light distribution pattern needs to be emitted and the range where the ADB light distribution pattern needs not to be emitted, based on the position and type of the target object.

STEP18 of this example is the same as STEP18 of the fourth example.

Next, STEP19 will be described. As illustrated in FIG. 7, once STEP18 is executed, the lamp control unit 50 controls the on/off of each light source provided in the ADB high beam lamp based on the emission range information generated in STEP17 (STEP19). As a result, as illustrated in FIG. 12, the ADB light distribution patterns are not emitted to the area where the oncoming vehicle 1H is present.

Here, referring to FIG. 12, the light distribution pattern P formed when light is emitted from the right lamp unit 60 to the first reference direction and the light distribution pattern PA emitted when the orientation of the right optical unit 61 is moved 1 degree downward from the first reference direction will be described. In FIG. 12, the light distribution pattern P is drawn by a dashed line, and the light distribution pattern PA is drawn by a solid line. In this example, the low beam light distribution pattern included in the light distribution pattern P is the same as the low beam light distribution pattern PL of the fourth example.

Since the ADB light distribution pattern is controlled to ensure that, in principle, it is not emitted to an area where an oncoming vehicle is present, when the light distribution pattern P is emitted, the ADB light distribution pattern included in the light distribution pattern P is not emitted to the oncoming vehicle 1H, as illustrated in FIG. 12. Meanwhile, the low beam light distribution pattern included in the light distribution pattern P is emitted to an area above a headlamp of the oncoming vehicle 1H in the up-down direction. Therefore, when the light distribution pattern P is emitted, it causes glare to the oncoming vehicle 1H.

Meanwhile, when the light distribution pattern PA is emitted, the ADB light distribution pattern included in the light distribution pattern PA is not emitted to the oncoming vehicle 1H. Further, the low beam light distribution pattern included in the light distribution pattern PA is emitted to an area below the headlamp of the oncoming vehicle 1H. Thus, when the light distribution pattern PA is emitted, it causes glare to the oncoming vehicle 1H. Further, for the same reasons as in the fourth example, in this example, the downward movement amount of the emission direction of the low beam light distribution pattern when the target object is an oncoming vehicle is set to 1 degree. Thus, the vehicle lamp 10 may displace the first emission direction and the second emission direction by an appropriate movement amount based on the type of the target object, thereby avoiding any unnecessary deterioration in long-distance visibility.

In this example as well, the processes from STEP11 to STEP19 are repeatedly executed while the vehicle 1 is traveling. The process of lowering the emission direction when the target object is a preceding vehicle, and the process of not lowering the emission direction when the target object is a traffic sign, are the same as in the fourth example. In this example as well, the vehicle lamp 10 exerts the same effects as those in the fourth example.

### SECOND EMBODIMENT

Next, a vehicle lamp 110 according to the present embodiment will be described below with reference to FIGS. 1 and 2. Among components of the vehicle lamp 110 according to the present embodiment, the same components as those in the vehicle lamp 10 according to the first embodiment will be designated by the same reference numerals, and descriptions thereof will be omitted. A vehicle 100 according to the present embodiment differs from the vehicle 1 according to the first embodiment in that it includes the vehicle lamp 110 instead of the vehicle lamp 10. The vehicle lamp 110 according to the present embodiment differs from the vehicle lamp 10 according to the first embodiment in that it includes a right lamp unit 160 and a left lamp unit 170 instead of the right lamp unit 60 and the left lamp unit 70.

The right lamp unit 160 includes a lamp body (not illustrated), an outer cover (not illustrated), a right optical unit 161 arranged inside a lamp chamber formed by the lamp body and the outer cover, and a right drive unit 162 arranged inside the lamp chamber. The left lamp unit 170 includes a lamp body (not illustrated), an outer cover (not illustrated), a left optical unit 171 arranged inside the lamp chamber formed by the lamp body and the outer cover, and a left drive unit 172 arranged inside the lamp chamber.

The right optical unit 161 is configured to emit at least an adaptive driving beam (ADB) light distribution pattern. The right optical unit 161 includes, for example, an ADB high beam lamp. The right optical unit 161 may also be configured to emit not only an ADB light distribution pattern but also a low beam light distribution pattern. In this case, the right optical unit 161 includes an ADB high beam lamp and a low beam lamp. The low beam lamp emits a low beam light distribution pattern to an area including a lower position than the ADB light distribution pattern. The right optical unit 161 includes a light source and projection lens, which are, for example, the same as the light source and the projection lens included in the right optical unit 61 according to the first embodiment. Further, the light source of the right optical unit 161 may be constituted with micro LEDs, for example, as a light source for the ADB high beam lamp. The right optical unit 161 may be constituted with, for example, at least one light source, a drive mirror, and an optical system including a lens, a mirror, and similar components.

The right drive unit 162 is, for example, a leveling actuator. The right drive unit 162 includes a motor and a screw, which are, for example, the same as the motor and the screw included in the right drive unit 62 according to the first embodiment. The right drive unit 162 may displace the orientation of the right optical unit 161 in the up-down direction based on the same principle as the right drive unit 62 according to the first embodiment, which displaces the orientation of the right optical unit 61 in the up-down direction.

The configuration of the left lamp unit 170 is the same as that of the right lamp unit 160, and thus, will not be described.

### First Example of Second Embodiment

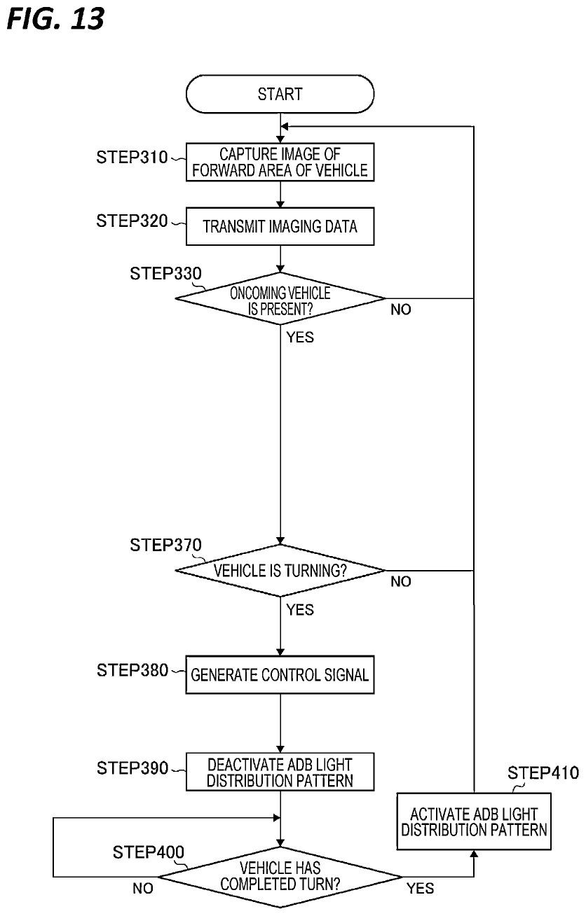

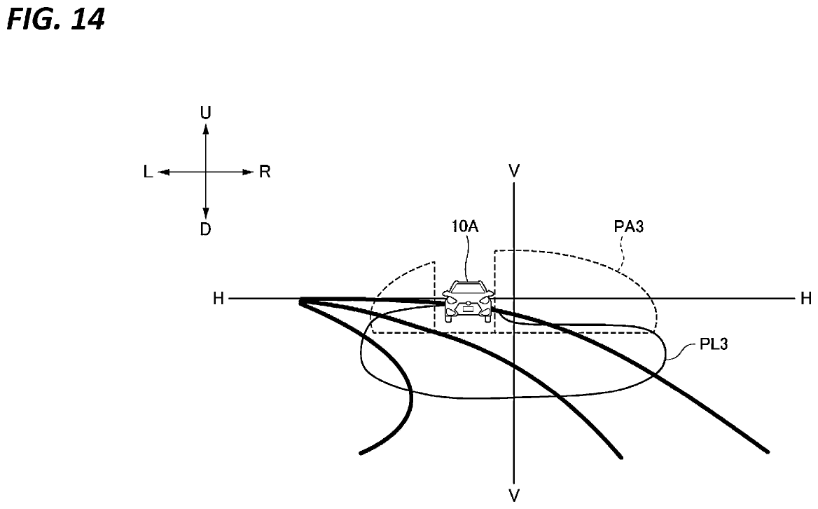

Next, an ADB light distribution pattern PA3 and a low beam light distribution pattern PL3 emitted in this example will be described with reference to FIGS. 13 and 14. FIG. 13 is a flowchart illustrating processes performed in a first example of a second embodiment. FIG. 14 is a diagram illustrating an ADB light distribution pattern PA3 and a low beam light distribution pattern PL3 emitted by the right lamp unit 160 in the first example of the second embodiment. In this example, the right optical unit 161 emits the ADB light distribution pattern PA3. Furthermore, the right optical unit 161 also emits the low beam light distribution pattern PL3. Since the ADB light distribution pattern and the low beam light distribution pattern emitted by the left lamp unit 170 are the same as the ADB light distribution pattern PA3 and the low beam light distribution pattern PL3 emitted by the right lamp unit 160, the following description will focus on a case where the right lamp unit 160 emits the ADB light distribution pattern PA3 and the low beam light distribution pattern PL3, and the description of the left lamp unit 170 will be omitted. Further, FIG. 14 illustrates the V-V line indicating the vertical direction (up-down direction in FIG. 14) at the emission range center of the right lamp unit 160 and the H-H line perpendicular to the V-V line and extending in the horizontal direction (left-right direction in FIG. 14). The V-V line represents an example of the left-right direction center in front of the vehicle 100.

In this example, a case where the vehicle 100 is traveling in the left lane on a level road with no gradient will be described. FIG. 14 illustrates the ADB light distribution pattern PA3 formed when light is emitted from the right lamp unit 160 in the initial state, as drawn by a dashed line. Further, FIG. 14 illustrates the low beam light distribution pattern PL3 formed when light is emitted from the right lamp unit 160 in this example, as drawn by a solid line. The ADB light distribution pattern PA3 and the low beam light distribution patterns PL3 illustrated in FIG. 14 are projections on a virtual vertical screen at a predetermined position in front of the vehicle 100 (e.g., position 25 meters ahead of the vehicle 100).

As illustrated in FIG. 13, the camera 20 captures images of a forward area of the vehicle 100 and acquires imaging data related to the forward area (STEP310). The camera 20 may capture images of the forward area of the vehicle 100 at predetermined intervals. The camera 20 transmits the imaging data to the vehicle control unit 40 (STEP320).

The vehicle control unit 40 analyzes the imaging data to determine whether an oncoming vehicle 10A is present (STEP330). When the vehicle control unit 40 determines that the oncoming vehicle 10A is not present (NO in STEP330), the vehicle control unit 40 returns the process to STEP310. When the vehicle control unit 40 determines that the oncoming vehicle 10A is present (YES in STEP330), the vehicle control unit 40 transmits a signal indicating this to the lamp control unit 50 to proceed with the process.

Further, the vehicle control unit 40 determines whether the vehicle 100 is turning or not (STEP370). The vehicle control unit 40 may receive a signal from the steering device 30, indicating that the steering device 30 has been operated, and when such a signal is received, may determine that the vehicle 100 is turning. For example, the vehicle control unit 40 may analyze the imaging data received from the camera 20 to determine whether the lane that the vehicle 100 is traveling in curves in front of the vehicle 100. The vehicle control unit 40 may determine whether the lane that the vehicle 100 is traveling in curves based on position information of the vehicle 100 from a GPS (not illustrated) or a storage (not illustrated) and map information. In any case, when the vehicle control unit 40 determines that the vehicle 100 is traveling within a predetermined turning radius, the vehicle control unit 40 will determine that the vehicle 100 is turning. When the vehicle control unit 40 determines that the vehicle 100 is turning (YES in STEP370), the vehicle control unit 40 transmits a signal indicating this to the lamp control unit 50 to proceed with the process. When the vehicle control unit 40 determines that the vehicle 100 is not turning (NO in STEP370), the vehicle control unit 40 returns the process to STEP310.

The lamp control unit 50 calculates the emission range of the right lamp unit 160 based on the first emission area information, and calculates the emission range of the left lamp unit 170 based on the second emission area information. The lamp control unit 50 generates emission range information by calculating the emission ranges of the right lamp unit 160 and the left lamp unit 170. The emission range information is information for distinguishing between the range where the low beam light distribution pattern needs to be emitted and the range where the low beam light distribution pattern needs not to be emitted, within the range the vehicle lamp 110 may emit light. Furthermore, when receiving a signal indicating the presence of the oncoming vehicle 10A and a signal indicating that the vehicle 100 is turning from the vehicle control unit 40, the lamp control unit 50 generates a control signal to deactivate the ADB light distribution pattern PA3 of the right lamp unit 160 (STEP380). After that, the lamp control unit 50 transmits the generated control signal to the right optical unit 161.

The right optical unit 161 that has received the control signal deactivates the ADB light distribution pattern PA3 of the right lamp unit 160 while continuing to emit the low beam light distribution pattern PL3 (STEP390). For example, the right optical unit 161 turn off all the micro LEDs that are a light source for the ADB high beam lamp, thereby deactivating the ADB light distribution pattern PA3 emitted from the right optical unit 161. Furthermore, the right optical unit 161 maintains the emission of the low beam light distribution pattern PL3 from the right optical unit 161.

At this time, the deactivation time T1 taken for the ADB light distribution pattern PA3 to switch from the activated state to the deactivated state is relatively short. The deactivation time T1 is, for example, less than 1 second. The deactivation time T1 is at least shorter than the activation time T2 taken for the ADB light distribution pattern PA3 to switch from the deactivated state to the activated state, which will be described later.

After that, the vehicle control unit 40 determines whether the vehicle 100 has completed the turn (STEP400). When the vehicle control unit 40 determines that the vehicle 100 is not done turning (NO in STEP400), the vehicle control unit 40 returns the process to before STEP400. When the vehicle control unit 40 determines that the vehicle 100 has completed the turn (YES in STEP400), the vehicle control unit 40 transmits a signal indicating this to the lamp control unit 50. When receiving the signal, the lamp control unit 50 controls the right optical unit 161 to emit the ADB light distribution pattern PA3 from the right lamp unit 160 (STEP410). For example, the right optical unit 161 turns on the micro LEDs to emit the ADB light distribution pattern PA3 from the right optical unit 161. At this time, the activation time T2 taken for the ADB light distribution pattern PA3 to switch from the deactivated state to the activated state is relatively long. The activation time T2 is, for example, 3 seconds or more.

Furthermore, the lamp control unit 50 may turn on the right optical unit 161 such that the ADB light distribution pattern PA3 gradually brightens. For example, the right optical unit 161 may be turned on such that the light intensity of the ADB light distribution pattern PA3 increases over time after the illumination start, based on the control signal from the lamp control unit 50. For example, the ADB light distribution pattern PA3 may remain deactivated (zero light intensity) immediately after the illumination start, but gradually brightens, returning to the standard brightness level after 3 seconds from the illumination start. After that, the lamp control unit 50 returns the process to before STEP310.

Here, as illustrated in FIG. 14, the ADB light distribution pattern generally excludes an area where the oncoming vehicle 10A is present from the emission range of the high beam light distribution pattern, adapting a non-emission area based on the presence or absence and position of the oncoming vehicle 10A. The ADB light distribution pattern is known to be effective in preventing glare to the occupant of the oncoming vehicle 10A. However, for example, when the vehicle 100 is turning, the relative orientation and distance between the vehicle 100 and the oncoming vehicle 10A may change constantly, and the emission direction of the ADB light distribution pattern PA3 of the right lamp unit 160 may also change. Therefore, when the vehicle 100 is turning, the likelihood of causing glare to the occupant of the oncoming vehicle 10A increases compared to when the vehicle 100 is traveling straight.

According to the vehicle lamp 110 of the first example of the second embodiment, when the vehicle 100 is turning and the oncoming vehicle 10A is present in front of the vehicle 100, the ADB light distribution pattern PA3 of the right lamp unit 160 is deactivated. Therefore, glare to the occupant of the oncoming vehicle 10A may be further reduced.

According to the vehicle lamp 110 of the first example of the second embodiment, the deactivation time T1 taken for the ADB light distribution pattern PA3 to switch from the activated state to the deactivated state is shorter than the activation time T2 taken for the ADB light distribution pattern PA3 to switch from the deactivated state to the activated state. Therefore, the ADB light distribution pattern PA3 may be immediately deactivated to prevent glare to the occupant of the oncoming vehicle 10A, while the ADB light distribution pattern PA3 may be activated to avoid discomfort to the occupant of the vehicle 100.

Further, when the ADB light distribution pattern were to be activated immediately, the light intensity of the ADB light distribution pattern would suddenly changes, causing discomfort to the occupant of the vehicle 100 with the ADB light distribution pattern PA3. However, according to the vehicle lamp 110 of the first example of the second embodiment, the lamp control unit 50 controls the right optical unit 161 to activate the ADB light distribution pattern PA3 so that the ADB light distribution pattern PA3 gradually brightens. In this case, since the change in the light intensity of the ADB light distribution pattern PA3 is relatively small during transition from the deactivated state to the activated state of the ADB light distribution pattern PA3, the occupant of the vehicle 100 is less likely to feel discomfort with the ADB light distribution pattern PA3.

The lamp control unit 50 may control the right optical unit 161 to activate the ADB light distribution pattern PA3 so that the ADB light distribution pattern PA3 gradually brightens. For example, during transition from the deactivated state to the activated state of the ADB light distribution pattern PA3, the brightness of the ADB light distribution pattern may change in two stages: from a first state to a second state brighter than the first state, and then from the second state to a third state brighter than the second state. Even in this case, the change in the light intensity of the ADB light distribution pattern is relatively small compared to the immediate activation of the ADB light distribution pattern, making it less likely for the occupant of the vehicle 100 to feel discomfort with the ADB light distribution pattern PA3.

Furthermore, the lamp control unit 50 may start activation of the ADB light distribution pattern PA3 from the right optical unit 161 after a predetermined time from the reception of a signal indicating that the vehicle 100 has completed the turn. For example, the lamp control unit 50 may control the right optical unit 161 to start activation of the ADB light distribution pattern PA3 after two seconds from the reception of the signal indicating that the vehicle 100 has completed the turn. Even in this case, compared to the immediate start of activation of the ADB light distribution pattern, the change in the light intensity of the ADB light distribution pattern begins after the predetermined time, making it less likely for the occupant of the vehicle 100 to feel discomfort with the ADB light distribution pattern PA3.

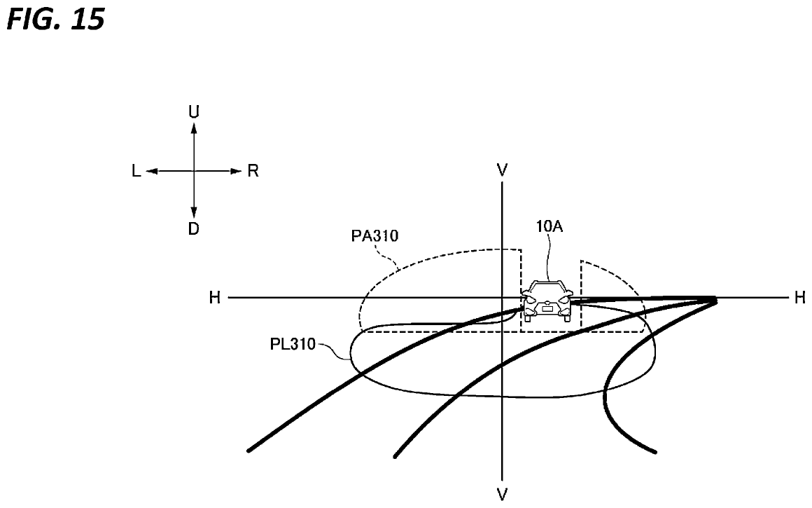

This example has described the case where the vehicle 100 is traveling in the left lane, but the same effect may be achieved even when the vehicle 100 is traveling in the right lane. FIG. 15 is a diagram illustrating a case where the vehicle 100 is traveling in the right lane, and an ADB light distribution pattern PA310 and a low beam light distribution pattern PL310 are emitted by the right lamp unit 160. As illustrated in FIG. 15, when the vehicle 100 is turning and the oncoming vehicle 10A is present in front of the vehicle 100, the ADB light distribution pattern PA310 emitted from the right lamp unit 160 may cause glare to the occupant of the oncoming vehicle 10A. However, according to the vehicle lamp 110 of the first example of the second embodiment, even when the vehicle 100 is traveling in the right lane, the ADB light distribution pattern PA310 of the right lamp unit 160 is deactivated, which enables a further reduction in glare to the occupant of the oncoming vehicle 10A.

In this example, when the vehicle control unit 40 determines that the oncoming vehicle 10A is present (YES in STEP 330), the vehicle control unit 40 transmits a signal indicating this to the lamp control unit 50 to proceed with the process. At this time, the vehicle control unit 40 may generate position information for the oncoming vehicle 10A. The position information for the oncoming vehicle 10A is, for example, an angular coordinate indicating the azimuth of the oncoming vehicle 10A as seen from the vehicle 100. The vehicle control unit 40 transmits the position information for the oncoming vehicle 10A to the lamp control unit 50. When the lamp control unit 50 receives the position information for the oncoming vehicle 10A, the lamp control unit 50 may determine whether the position information for the oncoming vehicle 10A is included within the emission range of the ADB light distribution pattern PA3. When the lamp control unit 50 determines that the position information for the oncoming vehicle 10A is included within the emission range of the ADB light distribution pattern PA3, the lamp control unit 50 may control the right optical unit 161 to deactivate the ADB light distribution pattern PA3.

In this example, the lamp control unit 50 is provided in the vehicle lamp 110. However, the lamp control unit 50 may be provided in the vehicle 100 instead of the vehicle lamp 110. In other words, the lamp control unit 50 may be integrated into the vehicle control unit 40. For example, in this example, the lamp control unit 50 generates a control signal such that the deactivation time T1 taken for the ADB light distribution pattern PA3 to switch from the activated state to the deactivated state is shorter than the activation time T2 taken for the ADB light distribution pattern PA3 to switch from the deactivated state to the activated state, but the vehicle control unit 40 may generate this control signal.

### Second Example of Second Embodiment

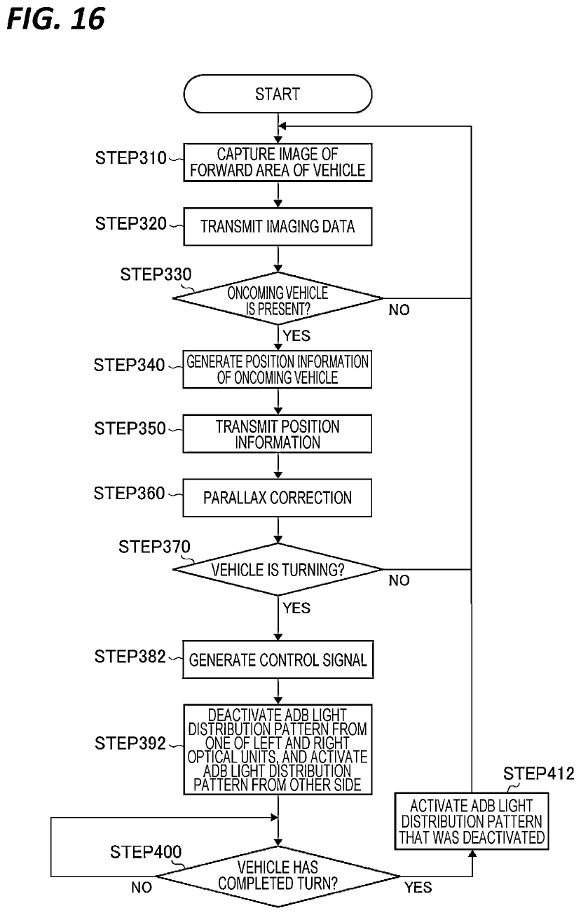

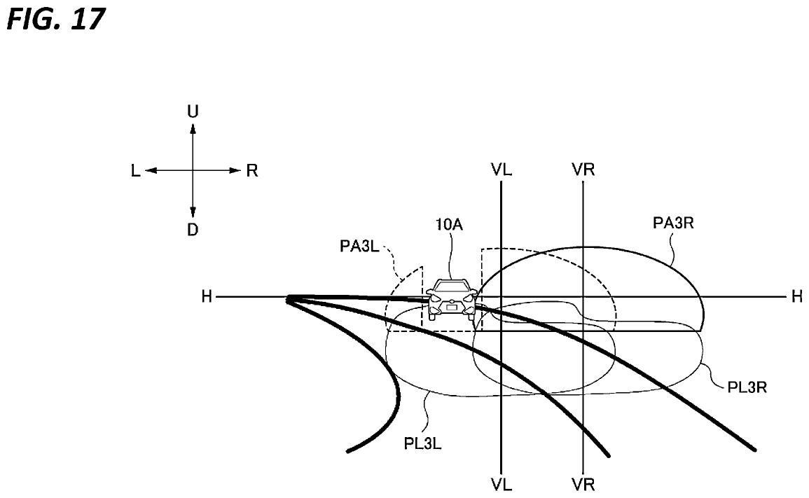

Next, other processes according to the second embodiment will be described with reference to FIGS. 16 and 17. FIG. 16 is a flowchart illustrating processes performed in a second example of the second embodiment. In the processes illustrated in FIG. 16, the same processes as those illustrated in FIG. 13 are designated by the same reference numerals, and descriptions thereof will be omitted. For example, STEP310 to STEP330 illustrated in FIG. 16 are the same as STEP310 to STEP330 illustrated in FIG. 13, and thus, descriptions thereof will be omitted. Among components illustrated in FIG. 17, the same components as those illustrated in FIG. 14 are designated by the same reference numerals, and descriptions thereof will be omitted.

In the first example of the second embodiment, the ADB light distribution pattern emitted by the left lamp unit 170 was the same as the ADB light distribution pattern emitted by the right lamp unit 160, but in this example, these patterns are different. Furthermore, in the first example of the second embodiment, the low beam light distribution pattern emitted by the left lamp unit 170 was the same as the low beam light distribution pattern emitted by the right lamp unit 160, but in this example, these patterns are different. FIG. 17 is a diagram illustrating, in this example, an ADB light distribution pattern PA3R and a low beam light distribution pattern PL3R emitted by the right lamp unit 160, and an ADB light distribution pattern PA3L and a low beam light distribution pattern PL3L emitted by the left lamp unit 170. FIG. 17 illustrates the VR-VR line indicating the vertical direction (up-down direction in FIG. 17) at the emission range center of the right lamp unit 160, the VL-VL line indicating the vertical direction (up-down direction in FIG. 17) at the emission range center of the left lamp unit 170, and the H-H line perpendicular to both the VR-VR line and the VL-VL line and extending in the horizontal direction (left-right direction in FIG. 17).

In this example as well, a case where the vehicle 100 is traveling in the left lane on a level road with no gradient will be described. FIG. 17 illustrates the ADB light distribution pattern PA3R as drawn by a solid line and the low beam light distribution pattern PL3R as drawn by a solid line, which are formed when light is emitted from the right lamp unit 160 in the initial state. Furthermore, FIG. 17 illustrates the ADB light distribution pattern PA3L as drawn by a dashed line and the low beam light distribution pattern PL3L as drawn by a solid line, which are formed when light is emitted from the left lamp unit 160 in the initial state. The ADB light distribution pattern PA3R, low beam light distribution pattern PL3R, ADB light distribution pattern PA3L, and low beam light distribution pattern PL3L illustrated in FIG. 17 are projections on a virtual vertical screen at a predetermined position in front of the vehicle 100 (e.g., position 15 to 20 meters ahead of the vehicle 100).

As illustrated in FIG. 16, when the vehicle control unit 40 determines that the oncoming vehicle 10A is present (YES in STEP330), the vehicle control unit 40 generates position information for the oncoming vehicle 10A from the imaging data (STEP340). The position information for the oncoming vehicle 10A is, for example, an angular coordinate indicating the azimuth of the oncoming vehicle 10A as seen from the vehicle 100. The vehicle control unit 40 transmits the position information for the oncoming vehicle 10A to the lamp control unit 50 (STEP350).

When receiving the position information for the oncoming vehicle 10A, the lamp control unit 50 performs parallax correction on the position information (STEP360). As illustrated in FIG. 1, since the installation position of the right lamp unit 160 in the vehicle 100 is different from the installation position of the camera 20, there is a misalignment (parallax) between the emission direction of the right lamp unit 160 (i.e., first emission direction) and the imaging direction of the camera 20. Similarly, since the installation position of the left lamp unit 170 in the vehicle 100 is different from the installation position of the camera 20, there is a misalignment (parallax) between the emission direction of the left lamp unit 170 (i.e., second emission direction) and the imaging direction of the camera 20. Therefore, the position of the oncoming vehicle 10A generated from the imaging data of the camera 20 corresponds to the position indicated in the imaging direction of the camera 20, and is different from the positions in the emission direction of the right lamp unit 160 and the emission direction of the left lamp unit 170. The lamp control unit 50 performs parallax correction on the position information for the oncoming vehicle 10A received from the vehicle control unit 40, thereby generating first position information parallax-corrected on the first emission direction and the second emission direction.

After that, the vehicle control unit 40 determines whether the vehicle 100 is turning (STEP370). When the vehicle control unit 40 determines that the vehicle 100 is turning (YES in STEP370), the vehicle control unit 40 transmits a signal indicating this to the lamp control unit 50 to proceed with the process. When the vehicle control unit 40 determines that the vehicle 100 is not turning (NO in STEP370), the vehicle control unit 40 returns the process to STEP310.

When the lamp control unit 50 receives, from the vehicle control unit 40, a signal indicating the position information for the oncoming vehicle 10A and a signal indicating that the vehicle 100 is turning, the lamp control unit 50 generates a control signal to emit the ADB light distribution pattern PA3R of the right lamp unit 160 and a control signal to deactivate the ADB light distribution pattern PA3L of the left lamp unit 170 (STEP382). These control signals also include instructions to continue emitting the low beam light distribution pattern PL3R of the right lamp unit 160 and the low beam light distribution pattern PL3L of the left lamp unit 170. The control signals may change the activation or deactivation of these light distribution patterns according to whether the oncoming vehicle 10A is present, whether the vehicle 100 is turning, and which direction the vehicle 100 is turning (whether toward the vehicle own lane side or the opposing lane side). For example, FIG. 17 illustrates a case where the oncoming vehicle 10A is present (YES in STEP330), the vehicle 100 is turning (YES in STEP370), and the vehicle 100 is turning to the left (toward the vehicle own lane side). In this case, the lamp control unit 50 generates a control signal to emit the ADB light distribution pattern PA3R of the right lamp unit 160 and to deactivate the ADB light distribution pattern PA3L of the left lamp unit 170. Furthermore, the lamp control unit 50 generates a control signal to continue emitting the low beam light distribution pattern PL3R of the right lamp unit 160 and the low beam light distribution pattern PL3L of the left lamp unit 170. After that, the lamp control unit 50 transmits the generated control signal to the right optical unit 161 and the left optical unit 171.

The right optical unit 161 that has received the control signal continues to emit the ADB light distribution pattern PA3R of the right lamp unit 160 while continuing to emit the low beam light distribution pattern PL3R. Furthermore, the left optical unit 171 that has received the control signal deactivates the ADB light distribution pattern PA3L of the left lamp unit 170 while continuing to emit the low beam light distribution pattern PL3L (STEP392). For example, the left optical unit 171 turns off all the micro LEDs that are a light source for the ADB high beam lamp, thereby deactivating the ADB light distribution pattern PA3L emitted from the left optical unit 171.

After that, the vehicle control unit 40 determines whether the vehicle 100 has completed the turn (STEP400). When the vehicle control unit 40 determines that the vehicle 100 is not done turning (NO in STEP400), the vehicle control unit 40 returns the process to before STEP400. When the vehicle control unit 40 determines that the vehicle 100 has completed the turn (YES in STEP400), the vehicle control unit 40 transmits a signal indicating this to the lamp control unit 50. When receiving the signal, the lamp control unit 50 controls the left optical unit 171 to emit the ADB light distribution pattern PA3L of the right lamp unit 170, which was previously deactivated (STEP412). For example, the left optical unit 171 turns on the micro LEDs of the ADB high beam lamp, so that the ADB light distribution pattern PA3L is emitted from the left optical unit 171. After that, the lamp control unit 50 returns the process to STEP310.

In conventional ADB light distribution patterns, the left and right ADB light distribution patterns are emitted, and only the area overlapping the position of the oncoming vehicle 10A was set to a non-emission area. In this case, accurate and immediate control is required in response to changes in the position of the oncoming vehicle 10A. As described above, according to the vehicle lamp 110 of the second example of the second embodiment, the ADB light distribution pattern from one of the two optical units on the left and right is deactivated according to whether the oncoming vehicle 10A is present and whether the vehicle 100 is turning. This may allow for relatively simple control to prevent glare to the occupant of the oncoming vehicle while still maintaining long-distance visibility in front of the vehicle by emitting the ADB light distribution pattern from the other side, compared to the conventional ADB light distribution pattern control.

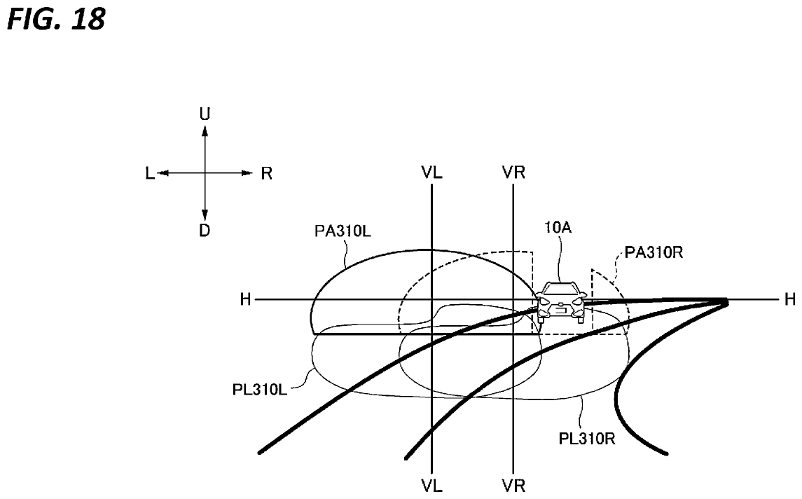

This example has described the case where the vehicle 100 is traveling in the left lane, but the same effect may be achieved even when the vehicle 100 is traveling in the right lane. FIG. 18 is a diagram illustrating an ADB light distribution pattern PA310R and a low beam light distribution pattern PL310R emitted by the right lamp unit 160, and an ADB light distribution pattern PA310L and a low beam light distribution pattern PL310L emitted by the left lamp unit 170 when the vehicle 100 is traveling in the right line. As illustrated in FIG. 18, when the vehicle 100 is turning to the right (toward the vehicle own lane side) and the oncoming vehicle 10A is present in front of the vehicle 100, the ADB light distribution pattern PA310R emitted from the right lamp unit 160 may cause glare to the occupant of the oncoming vehicle 10A. However, according to the vehicle lamp 110 of the second example of the second embodiment, even when the vehicle 100 is traveling in the right lane, when the oncoming vehicle 10A is present and the vehicle 100 is turning to the right, the ADB light distribution pattern PA310R of the right lamp unit 160 is deactivated and the ADB light distribution pattern PA310L of the left lamp unit 170 is emitted. This may reduce glare to the occupant of the oncoming vehicle 10A and may ensure long-distance visibility in front of the vehicle. When the vehicle 100 is traveling in the right lane, the oncoming vehicle 10A is present, and the vehicle 100 is turning to the left (toward the opposing lane side), the ADB light distribution pattern PA310R of the right lamp unit 160 may be emitted and the ADB light distribution pattern PA310L of the left lamp unit 170 may be deactivated. Even in this case, glare to the occupant of the oncoming vehicle 10A may be reduced while ensuring long-distance visibility in front of the vehicle.

The first and second movement amounts illustrated in the first to third examples of the first embodiment are merely examples and are not limited to −0.2 degrees or −1 degree. In the present disclosure, when the oncoming vehicles 1A, 1B and 1C are on the vehicle own lane side of the left-right direction center in front of the vehicle 1, at least one of the absolute values of the first and second movement amounts is within the range of 0 degrees to 3 degrees. For example, even when the first movement amount is −1 degree and the second movement amount is 0 degrees (i.e., the second emission direction does not displace from the second reference direction), the above-described objectives may be achieved. Further, when the vehicle 1 is traveling uphill or depending on the position of the target object, both the first and second movement amounts may be calculated as 0 degrees (i.e., no movement of either the first or second emission direction is needed). Furthermore, when the vehicle 1 is traveling downhill, the absolute values of the first and second movement amounts may exceed 3 degrees.

The first and second movement amounts illustrated in the fourth to sixth examples of the first embodiment are merely examples and are not limited to 0 degrees, 0.3 degrees, and −1 degree. In the present disclosure, the absolute value of the first movement amount and the absolute value of the second movement amount may be within the range of 0 degrees to 3 degrees. Further, when the vehicle 1 is traveling uphill or depending on the position of the target object, the first and second movement amounts may be calculated as 0 degrees (i.e., no movement of the first and second emission directions is needed). Furthermore, when the vehicle 1 is traveling downhill, the absolute values of the first and second movement amounts may exceed 3 degrees.

In the first embodiment, the right lamp unit 60 includes the right optical unit 61 and the right drive unit 62, and the left lamp unit 70 includes the left optical unit 71 and the left drive unit 72, but the present disclosure is not limited to this. For example, when the right optical unit 61 and the left optical unit 71 are each constituted with at least one light source and an optical system including a drive mirror, the emission direction may be lowered by displacing the emission position of the entire light distribution pattern downward by controlling the drive mirror without changing the orientation of the entire optical unit. In this case, the right lamp unit 60 may not need to include the right drive unit 62, and the left lamp unit 70 may not need to include the left drive unit 72.

In the first to third examples of the first embodiment, when the oncoming vehicles 1A, 1B and 1C are on the vehicle own lane side of the left-right direction center in front of the vehicle 1, the lamp control unit 50 individually displaces the first and second emission directions in the up-down direction based on the positions of the oncoming vehicles 1A, 1B, and 1C, but the present disclosure is not limited to this. For example, when part of the oncoming vehicles 1A, 1B and 1C is on the vehicle own lane side of the left-right direction center in front of the vehicle 1, the lamp control unit 50 may individually displace the first and second emission directions in the up-down direction based on the positions of the oncoming vehicles 1A, 1B, and 1C.

In the fourth to sixth examples of the first embodiment, when the target object is on the vehicle own lane side of the V-V line, the lamp control unit 50 individually displaces the first and second emission directions in the up-down direction based on the type of target object, but the present disclosure is not limited to this. For example, when part of the target object is on the vehicle own lane side of the V-V line, the lamp control unit 50 may displace the first emission direction and the second emission direction in the up-down direction based on the type of the target object. When the target object is on the opposing lane side of the V-V line, the lamp control unit 50 may displace the first emission direction and the second emission direction in the up-down direction based on the type of the target object.

In the first embodiment, the lamp control unit 50 is installed in the vehicle lamp 10. However, the lamp control unit 50 may be installed in the vehicle 1 instead of the vehicle lamp 10. In other words, the lamp control unit 50 may be integrated into the vehicle control unit 40.

The first to third examples of the first embodiment have been described using the case where the target object is an oncoming vehicle, but the present disclosure is also applicable even when the target object is, for example, a preceding vehicle.

In the third and sixth examples of the first embodiment, both the right optical unit 61 and the left optical unit 71 emit low beam light distribution patterns and ADB light distribution patterns, but the present disclosure is not limited to this. For example, the right optical unit 61 may emit a low beam light distribution pattern and an ADB light distribution pattern, and the left optical unit 71 may emit only a low beam light distribution pattern. Further, the right optical unit 61 may emit only a low beam light distribution pattern, and the left optical unit 71 may emit a low beam light distribution pattern and an ADB light distribution pattern.

In the third example of the first embodiment, STEP09 is executed after STEP08, but STEP09 may be executed simultaneously with STEP08.

In the sixth example of the first embodiment, STEP19 is executed after STEP18, but STEP19 may be executed simultaneously with STEP18.

In the fourth to sixth examples of the first embodiment, the vehicle control unit 40 determines the type of the target object based on the light emitted from or reflected by the target object and changes in the distance between the vehicle 1 and the target object, but the present disclosure is not limited to this. The vehicle control unit 40 may determine the type of the target object based on only one of the light emitted from or reflected by the target object and changes in the distance between the vehicle 1 and the target object.

As described above, this specification discloses the following.
(1) A vehicle lamp, including:
a right optical unit arranged on a right side of a vehicle and configured to emit at least a low beam light distribution pattern;
a left optical unit arranged on a left side of the vehicle and configured to emit at least a low beam light distribution pattern; and
a lamp controller configured to individually displace, in an vertical direction, a first emission direction of the low beam light distribution pattern emitted by the right optical unit and a second emission direction of the low beam light distribution pattern emitted by the left optical unit, based on a position of a target object located in front of the vehicle.
(2) The vehicle lamp described in (1), wherein the lamp controller is configured to:
calculate a first movement amount of the first emission direction in the vertical direction based on the position and first emission area information regarding an emission area of the right optical unit, and displace the first emission direction by the first movement amount; and
calculate a second movement amount of the second emission direction in the vertical direction based on the position and second emission area information regarding an emission area of the left optical unit and displace the second emission direction by the second movement amount.
(3) The vehicle lamp described in (2), wherein an absolute value of the first movement amount is within a range of 0 degrees to 3 degrees relative to a first reference direction that corresponds to the first emission direction when the target object is not present in front of the vehicle, and
wherein an absolute value of the second movement amount is within a range of 0 degrees to 3 degrees relative to a second reference direction that corresponds to the second emission direction when the target object is not present in front of the vehicle.
(4) The vehicle lamp described in any one of (1) to (3), further comprising:
a right drive configured to displace an orientation of the right optical unit in the vertical direction; and
a left drive configured to displace an orientation of the left optical unit in the vertical direction,
wherein the lamp controller individually controls the right drive and the left drive based on the position.
(5) The vehicle lamp described in any one of (1) to (4), wherein when at least a part of the target object is on a vehicle own lane side of a left-right direction center in front of the vehicle, the lamp controller individually displaces the first emission direction and the second emission direction in the vertical direction based on the position.
(6) The vehicle lamp described in any one of (1) to (5), wherein at least one of the right optical unit and the left optical unit emits an adaptive driving beam (ADB) light distribution pattern.
(7) A vehicle lamp including:
an optical unit configured to emit at least a low beam light distribution pattern; and
a lamp controller configured to displace an emission direction of the low beam light distribution pattern in a vertical direction based on a type of a target object located in front of a vehicle where the vehicle lamp is mounted.
(8) The vehicle lamp described in (7), wherein the type is determined based on light generated from the target object or light reflected by the target object.
(9) The vehicle lamp described in (7) or (8), wherein the type of the target object is determined based on a change in a distance between the vehicle and the target object.
(10) The vehicle lamp described in any one of (7) to (9), wherein the lamp controller calculates a movement amount in the vertical direction of a reference direction that corresponds to the emission direction when the target object is not present in front of the vehicle, based on the type, and
wherein an absolute value of the movement amount is within a range of 0 degrees to 3 degrees relative to the reference direction.
(11) The vehicle lamp described in any one of (7) to (10), wherein the type is one of an oncoming vehicle, a preceding vehicle, and a traffic sign.
(12) The vehicle lamp described in (11), wherein when the target object is the oncoming vehicle or the preceding vehicle, the lamp controller downwardly displaces the reference direction that corresponds to the emission direction when the target object is not present in front of the vehicle, and
wherein when the target object is the traffic sign, the lamp controller does not displace the reference direction in the vertical direction.
(13) A vehicle lamp mounted on a vehicle including:
an optical unit configured to emit at least an adaptive driving beam (ADB) light distribution pattern; and
a lamp controller configured to control the optical unit,
wherein the lamp controller controls the optical unit to deactivate the ADB light distribution pattern when the vehicle is turning and an oncoming vehicle is present in front of the vehicle.
(14) The vehicle lamp described in (13), wherein a deactivation time taken for the ADB light distribution pattern to switch from an activated state to a deactivated state is shorter than an activation time taken for the ADB light distribution pattern to switch from the deactivated state to the activated state.
(15) The vehicle lamp described in (14), wherein the lamp controller controls the optical unit to activate the ADB light distribution pattern such that the ADB light distribution pattern gradually brightens.
(16) The vehicle lamp described in any one of (13) to (15), wherein the optical unit includes a left optical unit provided on a left side of the vehicle and a right optical unit provided on a right side of the vehicle,
wherein the lamp controller controls the left optical unit and the right optical unit, and
wherein when the vehicle is turning and an oncoming vehicle is present in front of the vehicle, the lamp controller controls one of the left optical unit and the right optical unit to emit the ADB light distribution pattern while deactivating the ADB light distribution pattern from the remaining optical unit.

From the foregoing, it will be understood that various examples of the present disclosure are described for illustrative purposes, and that various variations may be made without departing from the scope and idea of the present disclosure. Therefore, the various examples disclosed herein are not intended to limit the essential scope and ideas designated by each of the following claims.

What is claimed is:

1. A vehicle lamp comprising:
a right optical unit arranged on a right side of a vehicle and configured to emit at least a low beam light distribution pattern;
a left optical unit arranged on a left side of the vehicle and configured to emit at least a low beam light distribution pattern; and
a lamp controller configured to individually displace, in a vertical direction, a first emission direction of the low beam light distribution pattern emitted by the right optical unit and a second emission direction of the low beam light distribution pattern emitted by the left optical unit, based on a position of a target object located in front of the vehicle.

2. The vehicle lamp according to claim 1, wherein the lamp controller is configured to:
calculate a first movement amount of the first emission direction in the vertical direction based on the position and first emission area information regarding an emission area of the right optical unit, and displace the first emission direction by the first movement amount; and
calculate a second movement amount of the second emission direction in the vertical direction based on the position and second emission area information regarding an emission area of the left optical unit, and displace the second emission direction by the second movement amount.

3. The vehicle lamp according to claim 2, wherein an absolute value of the first movement amount is within a range of 0 degrees to 3 degrees relative to a first reference direction that corresponds to the first emission direction when the target object is not present in front of the vehicle, and
an absolute value of the second movement amount is within a range of 0 degrees to 3 degrees relative to a second reference direction that corresponds to the second emission direction when the target object is not present in front of the vehicle.

4. The vehicle lamp according to claim 1, further comprising:
a right drive configured to displace an orientation of the right optical unit in the up-down direction; and
a left drive configured to displace an orientation of the left optical unit in the up-down direction,
wherein the lamp controller individually controls the right drive and the left drive based on the position.

5. The vehicle lamp according to claim 1, wherein when at least a part of the target object is on a vehicle own lane side of a left-right direction center in front of the vehicle, the lamp controller individually displaces the first emission direction and the second emission direction in the up-down direction based on the position.

6. The vehicle lamp according to claim 1, wherein at least one of the right optical unit and the left optical unit emits an adaptive driving beam (ADB) light distribution pattern.

7. A vehicle lamp comprising:
an optical unit configured to emit at least a low beam light distribution pattern; and
a lamp controller configured to displace an emission direction of the low beam light distribution pattern in a vertical direction based on a type of a target object located in front of a vehicle where the vehicle lamp is mounted.

8. The vehicle lamp according to claim 7, wherein the type of the target object is determined based on light generated from the target object or light reflected by the target object.

9. The vehicle lamp according to claim 7, wherein the type of the target object is determined based on a change in a distance between the vehicle and the target object.

10. The vehicle lamp according to claim 7, wherein the lamp controller calculates a movement amount in the vertical direction of a reference direction that corresponds to the emission direction when the target object is not present in front of the vehicle, based on the type, and
an absolute value of the movement amount is within a range of 0 degrees to 3 degrees relative to the reference direction.

11. The vehicle lamp according to claim 7, wherein the type of the object is one of an oncoming vehicle, a preceding vehicle, and a traffic sign.

12. The vehicle lamp according to claim 11, wherein when the target object is the oncoming vehicle or the preceding vehicle, the lamp controller downwardly displaces the reference direction that corresponds to the emission direction when the target object is not present in front of the vehicle, and
when the target object is the traffic sign, the lamp controller does not displace the reference direction in the vertical direction.

13. A vehicle lamp comprising:
an optical unit configured to emit at least an adaptive driving beam (ADB) light distribution pattern; and
a lamp controller configured to control the optical unit,
wherein the lamp controller controls the optical unit to deactivate the ADB light distribution pattern when the vehicle is turning and an oncoming vehicle is present in front of a vehicle where the vehicle lamp is mounted.

14. The vehicle lamp according to claim 13, wherein a deactivation time taken for the ADB light distribution pattern to switch from an activated state to a deactivated state is shorter than an activation time taken for the ADB light distribution pattern to switch from the deactivated state to the activated state.

15. The vehicle lamp according to claim 14, wherein the lamp controller controls the optical unit to activate the ADB light distribution pattern such that the ADB light distribution pattern gradually brightens.

16. The vehicle lamp according to claim 13, wherein the optical unit includes a left optical unit provided on a left side of the vehicle and a right optical unit provided on a right side of the vehicle,
the lamp controller controls the left optical unit and the right optical unit, and
when the vehicle is turning and an oncoming vehicle is present in front of the vehicle, the lamp controller controls one of the left optical unit and the right optical unit to emit the ADB light distribution pattern while deactivating the ADB light distribution pattern from the remaining optical unit.
